(19) United States
(12) Patent Application Publication
(10) Pub. No.: US 2024/0420512 A1
(43) Pub. Date: Dec. 19, 2024

(54) INTERFACES AND SYSTEMS FOR IMPROVING AND FACILITATING FLEET MANAGEMENT

(71) Applicant: COMMERCE LOGIC, LLC, Lehi, UT (US)

(72) Inventor: Levi Sorenson, Lehi, UT (US)

(21) Appl. No.: 18/705,217

(22) PCT Filed: Jun. 21, 2023
(86) PCT No.: PCT/US2023/025902

§ 371 Date: Apr. 26, 2024

Related U.S. Application Data
(60) Provisional application No. 63/355,389, filed on Jun. 24, 2022.

(51) Int. Cl. G07B 15/06; G07C 5/00

(52) U.S. Cl. CPC G07B 15/063; G07C 5/008

(57) ABSTRACT

Systems and methods are provided for improved fleet management. For example, disclosed embodiments access toll transaction data received from one or more toll agencies, normalize the toll transaction data from each toll agency, access telematic data, normalize the telematic data, and generate a correlated trip dataset comprising the normalized toll transaction data and the normalized telematic data. Based on the correlated trip dataset, systems are configured to calculate a net present toll value, identify toll bill errors, identify pre-violations, and identify vehicle fraud and abuse.

### BACKGROUND

There are many different types of companies that manage fleets of vehicles for various purposes. Some vehicle fleets are purposed as passenger vehicles, while other fleets are purposed for delivery and cargo. For example, rental car companies must manage a fleet of vehicles that are rented out to individual renters or that are used as part of ridesharing. Transport and delivery companies manage fleets of vehicles comprising vehicles driven by various drivers employed by the companies. In some instances, these vehicle fleet owners outsource the management of their fleet to a fleet manager. In these instances, the fleet manager is in charge of managing several vehicle fleets across multiple customers.

Whether individually managed or managed by a third party, there are many different components of fleet management. For example, each vehicle must be equipped with a transponder which is read at various toll checkpoints. In some cases, vehicles have multiple transponders in order to travel different sets of tolled routes owned and operated by different toll companies. As these vehicles travel on tolled routes, they incur toll fees which are reflected in the toll bill(s) received from one or more toll agencies. It is estimated that between one and three percent of toll bills have errors, which means that some customers are paying significantly more than they should be. However, because the toll bill does not include detailed toll transaction data, it is very difficult for customers or fleet managers to identify when and where the errors are occurring in the toll bills.

Accordingly, there is an ongoing need and desire for improved systems, methods, and devices for fleet management, particularly, for improved systems, methods, and devices that can be utilized to improve toll transaction analysis associated with different fleets.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include systems, methods, and devices that can be utilized to facilitate fleet management, including facilitating procurement and reassignment of tags, error detection, and mitigation in fleet toll records, and analyzing and estimating valuations associated with the routing of different resources through disparate systems.

Some methods are directed to generating an improved dataset that correlates the toll transaction data received from various toll agencies to telematic data received from telematic tracking systems. For example, systems access toll transaction data that has been aggregated from one or more toll agencies. The toll agencies record different toll transaction data points based on tracking a vehicle's registered transponder passing through different toll checkpoints. Systems also receive telematic data from a telematic tracker associated with the vehicle. The toll transaction data can be compared with the telematic data in order to perform various analytics.

In some instances, based on comparing the toll transaction data with the telematic data, systems are able to identify specific toll transaction data points from the toll transaction data that correspond to specific telematic data points from the telematic data. Systems are able to identify corresponding data points based on identifying similar characteristics that are shared between the corresponding data points.

Systems also generate different correlation links for the corresponding data points such that each correlation link is configured to correlate a particular toll transaction data point to a particular telematic data point. After generating the correlation links, systems then generate a correlated dataset that includes the toll transaction data correlated to the telematic data based on the different correlation links that were generated. This correlated dataset can then be used in various downstream applications, such as error identification, vehicle transponder tag distribution, and net present toll value determinations, among other applications and analyses, as will be described in more detail below.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example architecture of a flow diagram for facilitating an improved fleet management system.

FIG. 2 illustrates an example diagram of the distribution of fleet management.

FIG. 3 illustrates an example architecture that includes a computing system that includes and/or that is capable of being utilized to implement the disclosed embodiments.

FIG. 4A illustrates an example embodiment of a user portal.

FIG. 4B illustrates an example embodiment of a correlated dataset.

FIG. 4C illustrates an example embodiment of a correlated trip dataset.

FIG. 5 illustrates example embodiments of discrepancies and errors found between toll transaction data and telemetric data.

FIG. 6 illustrates various example embodiments of different types of user portals.

FIGS. 7A-7D illustrates an example embodiment of a flow diagram for building a backend database of toll agencies and corresponding sensor checkpoints.

FIGS. 8A-8F illustrate various user interfaces associated with the flow diagram illustrated in FIG. 7.

FIG. 9 illustrates a process flow diagram comprising a plurality of acts associated with a method for generating a correlated trip dataset.

FIG. 10 illustrates a process flow diagram comprising a plurality of acts associated with a method for generating a net present toll value.

FIG. 11 illustrates a process flow diagram comprising a plurality of acts associated with a method for reassigning one or more vehicle tags.

FIG. 12 illustrates a process flow diagram comprising a plurality of acts associated with a method for identifying discrepancies between toll transaction data and fleet telematics data.

FIG. 13 illustrates a process flow diagram comprising a plurality of acts associated with a method for identifying fraud and abuse of a fleet vehicle.

FIG. 14 illustrates a process flow diagram comprising a plurality of acts associated with a method for generating a correlated dataset.

### DETAILED DESCRIPTION

Disclosed systems and methods can be utilized to facilitate fleet management, for example, by accessing toll transaction data received from one or more toll agencies, normalizing the toll transaction data from each toll agency, accessing telematic data, normalizing the telematic data, and generating correlated trip datasets comprising the normalized toll transaction data and the normalized telematic data.

The disclosed systems can also be utilized to use the correlated trip datasets to calculate net present toll values, identify toll bill errors, identify pre-violations, and identify vehicle fraud and abuse. Some systems are configured to identify customer fleets comprising a plurality of vehicles and to identify trips taken by the various vehicles included in the plurality of vehicles. The systems are also configured to access toll transaction data received from one or more toll agencies associated with the various fleet vehicles. The systems further access telematic data associated with the particular fleet vehicles which includes GPS coordinate data associated with the route(s) traveled by the particular vehicle(s) during the identified trip(s). After accessing the telematic data and the toll transaction data, the systems are configured to generate corresponding correlated trip datasets comprising the normalized toll transaction data and the normalized telematic data for the various vehicles/trips.

In some instances, prior to generating the correlated trip dataset, the systems are configured to normalize the toll transaction data and the telematic data such that the system is configured to identify data points in the toll transaction data that correlate with data points in the telematic data.

Some disclosed embodiments are also directed to methods for generating a net present toll value associated with a vehicle or vehicle fleet. In such embodiments, systems are configured to identify a customer fleet comprising a plurality of vehicles and access toll transaction data received from one or more toll agencies about the customer fleet. In addition to toll transaction data, the systems are also configured to access telematic data from the customer fleet. The telematic data includes a first set of GPS coordinate data associated with tolled routes traveled by the plurality of vehicles and a second set of GPS coordinate data associated with non-tolled routes traveled by the plurality of vehicles. In such instances, the tolled routes and non-tolled routes have corresponding departure and arrival destinations. Based on at least comparing the first set of GPS coordinate data and the second set of GPS coordinate data, the systems generate a net present toll value configured to indicate whether the tolled route, along with its associated toll fees, meets a net present toll value threshold.

Some disclosed embodiments are also directed to systems and methods for generating a set of assigned vehicle tags. For example, some systems are configured to identify one or more customer fleets (each customer fleet comprises one or more vehicles). Systems then access toll transaction data about one or more customer fleets. The toll transaction data is received from one or more different toll agencies. The systems are also configured to access telematic data associated with the plurality of vehicles included in each customer fleet. The telematic data includes GPS coordinate data associated with routes traveled by one or more vehicles during trips taken by one or more vehicles. After accessing the various data, the systems are configured to normalize the toll transaction data and the telematic data such that the systems are able to identify data points in the toll transaction data that correlate with data points in the telematic data.

In addition to accessing toll transaction data and telematic data, systems access tag fee data from each of one or more agencies and a set of assigned vehicle tags associated with the different customer fleets. Once the various data have been normalized, the systems generate a correlated trip dataset comprising the normalized toll transaction data and the normalized telematic data. Based on comparing the correlated trip dataset and the tag fee data, systems are configured to determine whether one or more vehicle tags in the set of vehicle tags should be reassigned in order to maximize monetary savings. In response to determining that one or more vehicle tags should be reassigned, the systems reassign one or more vehicle tags and update the set of assigned vehicle tags based on the tag reassignment.

Some disclosed embodiments are also directed to systems and methods for identifying errors in toll transaction data. For example, systems are configured to identify a customer fleet comprising a plurality of vehicles and identify a trip taken by a particular vehicle included in the plurality of vehicles. The systems then access toll transaction data about the particular vehicle that has been received from one or more toll agencies. The systems normalize the toll transaction data from each toll agency according to a first pre-determined standard formatting. In addition to the toll transaction data, the systems also access telematic data associated with the particular data. The telematic data includes GPS coordinate data associated with a route traveled by a particular vehicle during the trip.

After accessing the telematic data, the systems are configured to normalize the telematic data according to a second pre-determined standard formatting which corresponds to the first pre-determined standard formatting such that the systems are able to identify data points in the toll transaction data that correlate with data points in the telematic data. The systems are also configured to identify one or more discrepancies between the normalized toll transaction data and the normalized telematic data and generate one or more error alerts to a user which correspond to one or more discrepancies.

Some disclosed embodiments are also directed to systems and methods for detecting abuse and fraud in vehicle fleet management. identifying a customer fleet comprising a plurality of vehicles. For example, systems are configured for identifying a trip taken by a particular vehicle included in the plurality of vehicles and accessing a planned route associated with the trip that was generated prior to a trip departure. Systems are also configured to access telematic data associated with the particular vehicle and normalize the telematic data such that the systems identify data points in the planned route that correlate with data points in the telematic data. Next systems identify one or more discrepancies between the planned route and the normalized telematic data and generate one or more error alerts corresponding to the one or more discrepancies. One or more error alerts are configured to be presented to a user.

The disclosed embodiments provide many technical advantages over existing systems, methods, and devices for fleet management. For example, the disclosed embodiments provide for improved systems and methods for toll bill error identification and dispute management. Conventional systems do not provide a way in which to identify bill errors based on telematic data gathered from the vehicle. Without the correlated dataset of toll transaction data and the telematic data, the customer or fleet manager is ill-equipped to dispute anything in the toll bill that is incorrect. Furthermore, because of the improved communication between the customers, fleet managers, and toll companies, system users are better able to manage violations, including avoiding additional future violations by identifying sources that have caused the previous violations.

System users are also able to see further analytics, including a net present toll value for the various tolled routes that drivers are taking. In this manner, system users (e.g., customers and/or fleet managers) are able to determine which tolls are worth paying in order to achieve another goal (e.g., time savings). Because the toll transaction data can be correlated to historic telematic data as well as predicted telematic data (e.g., a planned route), system users are also able to quickly identify if any fraud is being committed against a customer by one of its drivers. Additionally, by comparing the toll transaction data with the predicted or historical telematic data, the system is able to identify fraud in the form of third-party tampering with or stealing a vehicle and/or vehicle transponder (e.g., if the transponder is in a different location than the vehicle and/or if the vehicle has taken an unauthorized route or abnormal route). These and many other benefits are described in further detail herein.

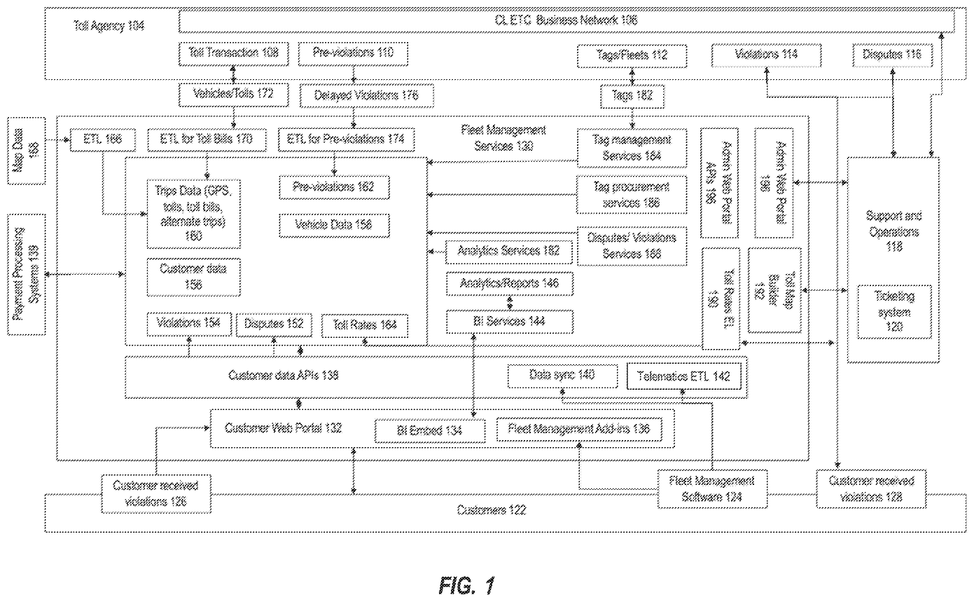

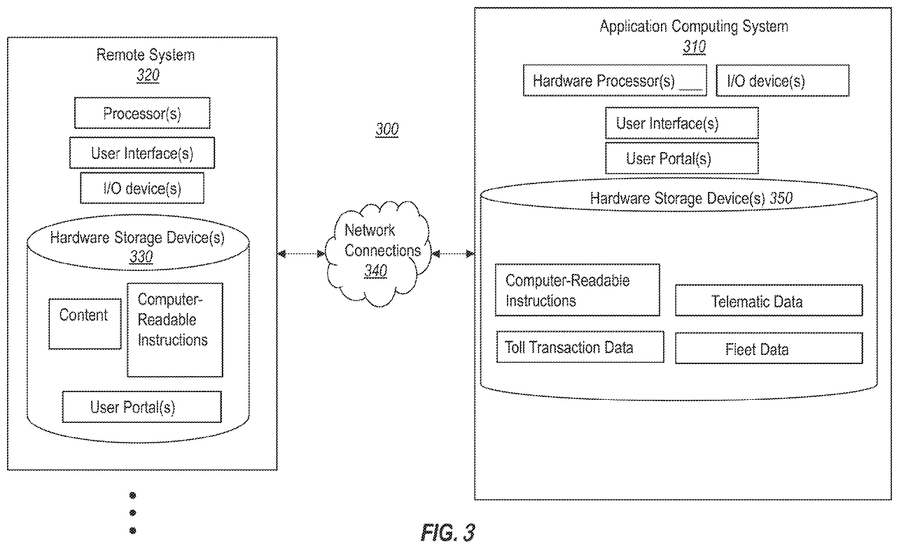

Attention will now be directed to FIG. 1, which illustrates an example embodiment of a flow diagram for a system configured to facilitate improved fleet management. For example, FIG. 3 is shown having at least one electronic toll collection (ETC) network (e.g., ETC network 102), customers 122, payment processing systems 139, fleet management support and operations 118, and fleet management services 130.

The fleet management support and operations 118 further comprise a ticketing system 120, wherein administrators and customers can submit tickets for different requests such as system updates, data updates, trouble-shooting assistance, etc. ETC networks are third-party networks/services that provide tolling services and are configured to generate toll transaction data for customers. The fleet management support and operations 118 also is configured to send requests/orders to tag manufacturers for tags to be manufactured and delivered to the fleet manager and/or customers.

The ETC network comprises one or more different toll agencies (e.g., toll agency 104) which manage different tolling systems implemented on various regions of road transportation infrastructure networks. The toll agency 104 manages at least one business account 106 which is a business account set up for a particular customer (e.g., customers 122) of the ETC network.

In some instances, all accounts associated with toll agency 104 belong to the fleet manager. Thus, there will be multiple customers on a toll agency account that the fleet manager owns. The fleet manager then separates the customer's toll transaction on the backend and assigns transactions to the fleet manager's customer accounts.

The toll agency 104 generates toll transaction data 108 for the customer, including toll bills for the customer associated with the business account 106. The toll agency also generates violation data (e.g., pre-violations 110 and violations 144) associated with business account 106. For example, if a vehicle in the customer's fleet has violated a toll agency protocol, toll agency 104 will generate a violation with a corresponding violation fee, in addition to the standard toll bills. These violations can be sent to fleet management support and operations 118 and/or directly to the customers 122.

In some instances, all agency and account relationships are with the fleet manager directly. In such instances, agencies do not send out pre-violations. Although, there are ways to determine pre-violations by working with agencies before violations are sent. Depending on the type of violation, the violation will be sent to the fleet manager's operation. Alternatively, if the customer is not identified as being associated with their fleet manager for some reason (i.e., stolen transponder) the violation will be sent directly to the customer based on the vehicle registration. Disclosed systems beneficially provide fleet managers with the ability to predict or detect some violations before an agency notifies anyone.

The toll agency 104 also receives and manages information about the tags 112 associated with a customer's fleet, as well as any disputes 116 submitted by the customer and/or fleet manager. The disputes 116 include disputes over toll transaction data 108, including miscalculated toll bills and/or violations 114 that have been improperly cited. As previously discussed, toll agencies do not typically monitor errors in their collected toll transaction data and/or the generated toll bills and violations. Thus, it is the customer's responsibility to review toll transaction data, including toll bills, and determine if there are any errors. If there are any errors, then the customer must contact the toll agency and submit a dispute for each item on the bill that they wish to resolve, have changed, or have removed.

However, in conventional systems, while toll agencies typically can provide the original toll transaction data upon which the toll bill is based, it is difficult to review and identify errors. The difficulty is compounded by the increasing complexity of the toll transaction data depending on the number of tolls, the size of the fleet, and the number of toll agencies being used. Thus, it is very difficult for customers to be able to review the toll bill and identify any errors, either in the calculation of the toll bill or errors that had been propagated from erroneously collected/recorded toll transaction data. It should be appreciated that some arrow between support and operations 118 and fleet management services 130 and other data are bidirectional arrows to indicate that some data is transmitted to the agency back office. For example, a vehicle list and/or other fleet data is shared between the customer system (and/or fleet management system) and the toll agency. Additional information about the fleet is also shared including vehicle plate numbers and/or tag assignment in some instances. Toll transaction data is also shared back and forth between the various systems via network communication or paper-trail communication (i.e., mail).

The disclosed embodiments are beneficially directed to systems and methods which provide customers and fleet managers with improved ways to analyze toll bills and violations in order to identify and dispute errors in the various toll transaction data. In addition, the disclosed embodiments allow customers and fleet managers to pre-emptively predict future violations and take preventative steps to mitigate the occurrence of such violations.

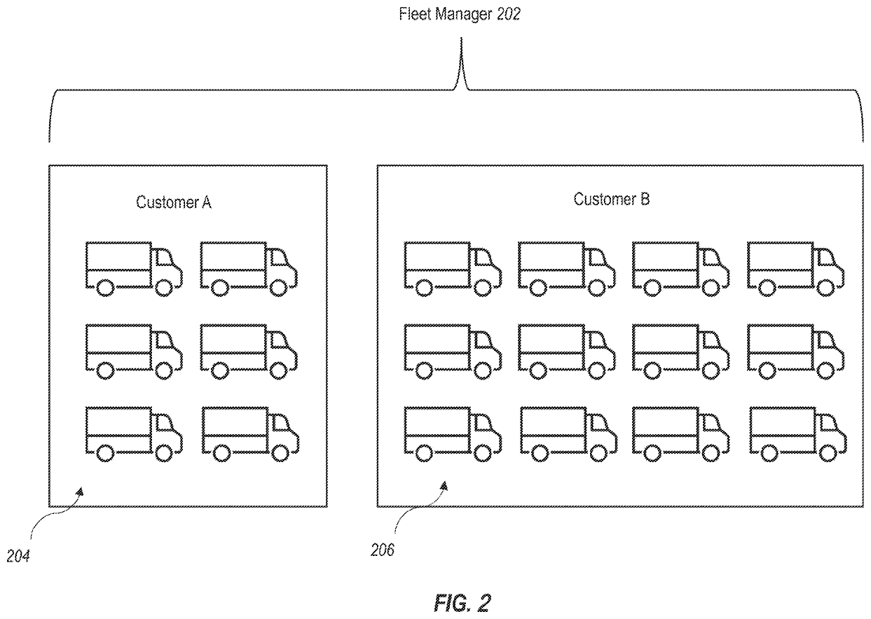

Attention will now be directed to FIG. 2, which illustrates an example embodiment of a fleet management hierarchy. Individual customers (e.g., Customer A, Customer B, etc.) own vehicle fleets (e.g., fleet 204, fleet 206, etc.) comprising one or more vehicles. In some instances, customers also manage their own fleets through a customer-facing fleet management software or program (see fleet management software 124 as illustrated in FIG. 1). Where customers choose to manage their fleets, customers set up business accounts with the respective toll agencies, determine the tag assignments, receive toll bills and violations directly from the toll agency. In some instances, customers outsource the management of their fleets to a third-party company or service, such as a third-party fleet management system. Customers can also outsource billing/toll transaction data management to a third party, such as a bill or toll consolidator.

By implementing fleet management systems such as the one illustrated in FIG. 2, fleet managers, like fleet manager 202, are able to manage one or more vehicle fleets associated with one or more clients. In some instances, the fleet management company is then responsible for the business account registered with the toll agency, the tag assignment, and distribution. The toll agency is able to send the toll bill to the customer who forwards it to the fleet management company, or alternatively, the toll agency sends the toll bill directly to the fleet management company and/or the bill consolidator company. The fleet manager is able to access toll transaction data through the customer, the toll agency, and/or the toll consolidator. This is in contrast to conventional practices where companies handle toll invoices and manage relationships with toll agencies by themselves.

Thus, it will be appreciated that the toll transaction data, as related to disclosed embodiments herein, can be obtained directly or indirectly from one or more different sources. For example, the billing and/or toll transaction data can be obtained from a tolling agency, from a customer (e.g., a customer who previously received the toll transaction data from the tolling agency), from a third party, such as a fleet manager or a bill consolidator (e.g., a third-party who previously received the toll transaction data from the customer and/or one or more tolling agencies), or a combination thereof. Furthermore, it will be appreciated that disclosed embodiments described herein can be implemented in the context of a fleet manager and/or a toll consolidator.

As illustrated in FIG. 1, system 100 comprises fleet management services 130. The fleet management services 130 comprise various user portals (e.g., administrator portal 196 and customer portal 132). The administrator portal 196 is in network communication with fleet management support and operations 118. The customer portal 132 is configured with a BI embedding 134 and one or more fleet management add-ins 136. Each customer is set up with their customer portal which is either a standard interface or customized interface based on the specific customer needs. The customer portal 132 is configured to allow customers 122 to input various data and upload information about bills, fleets, tags, drivers, violations, and communications for the fleet manager. This data is accessed by the fleet management services 130 via customer data APIs 138. The customer data APIs 138 are equipped with a data sync 140 which is configured to push and pull data to and from the customer portal 132 and one or more other data sources.

The customer data APIs 138 are also configured with a telematics ETL (extract, transform, and load) system 142 which is configured to extract, transform, and load telematics data from the customer's fleet management software (e.g., fleet management software 124). Examples of fleet management software include GeoTab, Salesforce, Samsora, etc. Such software systems are configured to record and collect telematics data about the customer's fleet(s), including individual vehicle routes, vehicle information, overall fleet information, and driver information, along with other information (e.g., weather, traffic, gas prices, etc.).

The information and data that has been obtained via the customer data APIs 138 is then transmitted to and/or stored in various system locations, including a hardware storage device 150 configured to store one or more databases (e.g., dispute database 152, violations database 154, customer information database 156, vehicle information database 158, trip information database 160, pre-violations database 162, and toll rates database 164. Data is also transmitted to and from other software services, including software analytics services 182, tag management services 184, tag procurement services 186, and disputes/violations services 188.

The business intelligence (BI) embedding 134 of the customer portal 132 is in communication with BI services 144 which is configured to transmit data stored in the customer portal 132 in order for the data to be analyzed. The analytics and reports data 146 are then used to provide software analytics services 182 (e.g., tolls, violations, saved time, etc.). The analytics and reports data 146 and further processed data provided through the software analytics services 182 are transmitted to and stored in one or more of the databases houses within hardware storage device 150. Additionally, toll transaction data 108 is extracted, transformed, and loaded (e.g., ETL for Toll Bills 170) such that the data has been normalized prior to being stored in the trip information database 160. The toll transaction data 108 is organized by vehicle or fleets of vehicles.

Third-party map data (e.g., map data 168) is also obtained and stored in the trip information database 160. Prior to being stored, the map data is extracted, transformed, and loaded into system 300 (e.g., ETL for map data 166). Map data 168 comprises topographical, geographical, and political data (e.g., state/country lines) as well as transportation infrastructure data (e.g., routes and speed limits of roads, highways, etc.). Map data 168 also comprises historical and current weather data and historical and current traffic data, including construction zones and road closures. This information is used along with telemetric data for the different vehicles in order to identify errors in bills and violations, identify/predict pre-violations based on historical violations, procure, and assign tags, and provide toll value assessments (i.e., saved time and money). The various software services systems also utilize data retrieved from the administrator portal 196 via the administrator portal APIs 194. The ability to facilitate and manage tag assignments is important in order for the system to identify an assignment distribution that maximizes discounts based on what routes the different customers are sending their vehicles.

The trip data stored in the trip information database 160 is then used to generate bills, as part of billing services. These bills are then processed and paid for using payment processing systems 139. For example, the invoices will be generated based on the transactions that the toll agencies have recorded. The trip data will be used to ensure bill accuracy from the agency. The trip data will also be used to identify toll transactions and violations, which can then be disputed with the agency if errors in either the toll bill or toll violations are found. Trip information is also configured to be used to predict toll bills, provide bill estimates, and identify any potential or future violations or issues.

By implementing fleet management systems, such as the fleet management system illustrated in FIG. 1, the invoices that are generated are improved invoices because they are based not just on the toll bills sent out by the tolling agencies, but also based on comparing the toll transaction data from the toll bills against telematic data. By ensuring the toll bills are accurate, the system prevents errors from being propagated from the toll bill into the customer invoice. Thus, the customer received a reviewed invoice which has improved accuracy over invoices generated by conventional methods (e.g., invoices that are based on data that does not include a correlated toll transaction and telematics dataset).

Similar to the toll transaction data, pre-violations 110 are also extracted, transformed, and loaded into the system (e.g., ETL for Pre-Violations 174) prior to being stored in the pre-violations database 162 such that the pre-violation data, including delayed violations 176, is normalized according to a system standard. This improves the data analysis processes because all of the data stored in the various databases are in the same format. This improves the accuracy of any data comparisons and calculations, as well as reduces the amount of time required to perform the data comparisons and calculations.

The data comparisons and calculations, such as predicted toll bills are based, in part, on the toll rates (e.g., as stored in toll rates database 164). Each toll agency sets its own toll rates for the various sensor checkpoints. These rates are also dynamically changing based on the time of day and/or time of year. For example, during heavy traffic (e.g., rush hour commute to and from the standard 9 am-5 pm workday) toll rates are increased. In contrast, low traffic (e.g., night-time) tolls are decreased. The fleet management support and operations 118 obtain and update the toll rates. Because each toll agency has its own rate structure, the toll rates that are obtained are in different formats. Thus, the disclosed embodiments beneficially extract, transform, and load the different toll rates into system 300 such that the toll rate data are normalized prior to being stored in the toll rates database 164. This improves downstream analysis and the use of the toll rate data by the different system services.

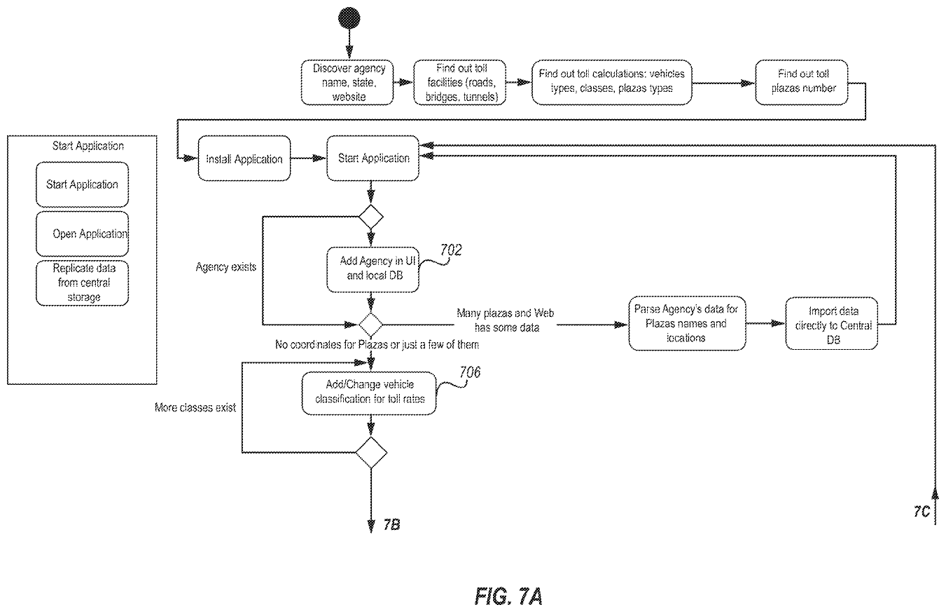

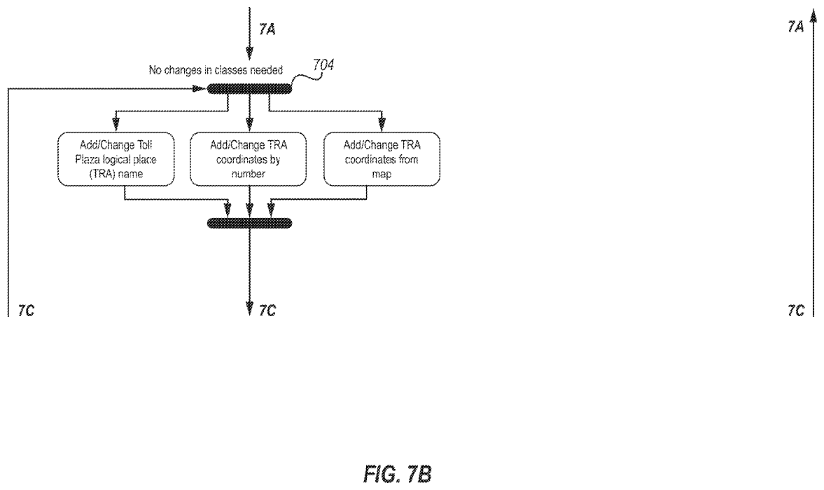

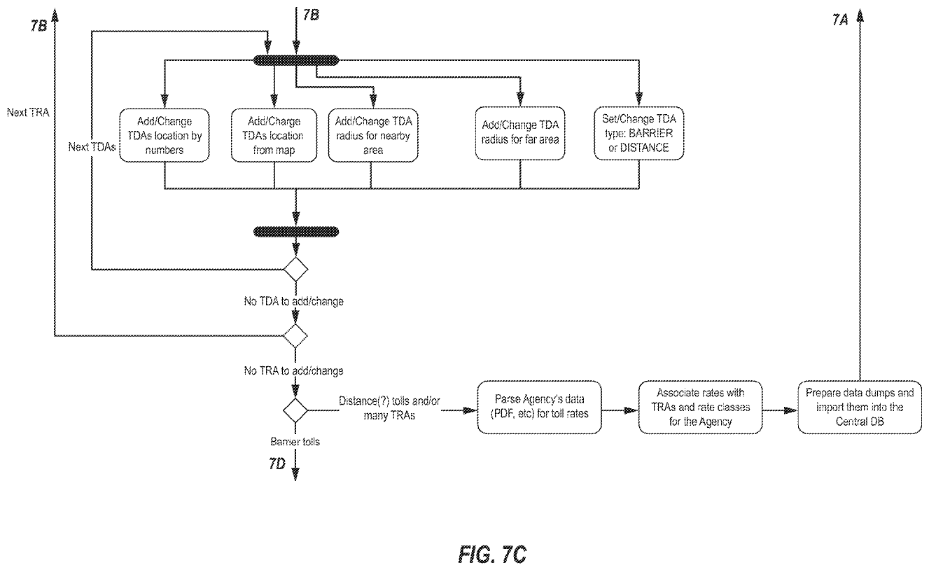

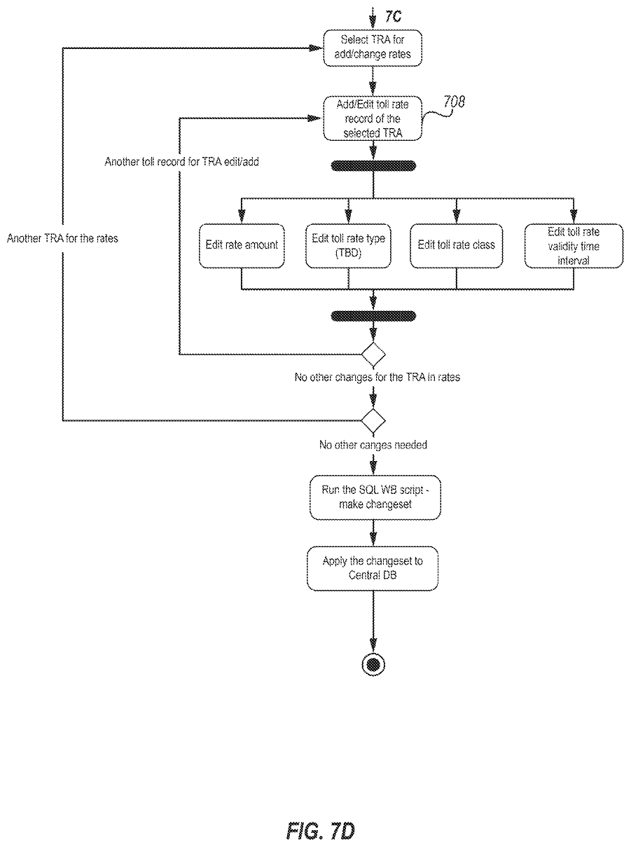

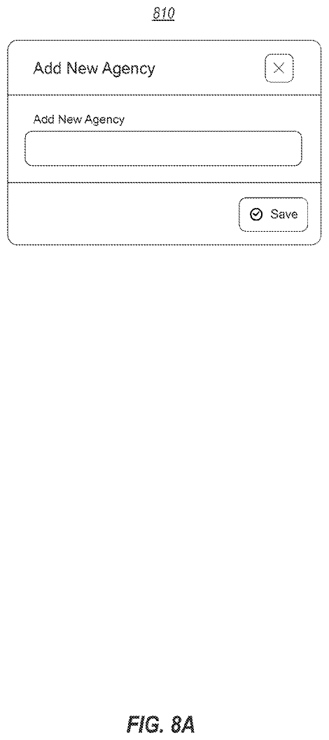

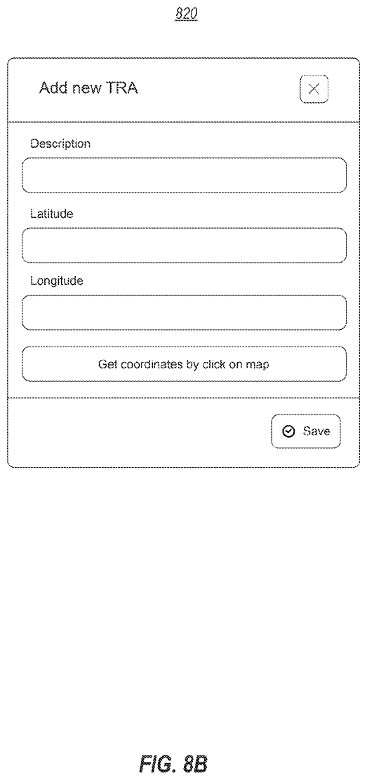

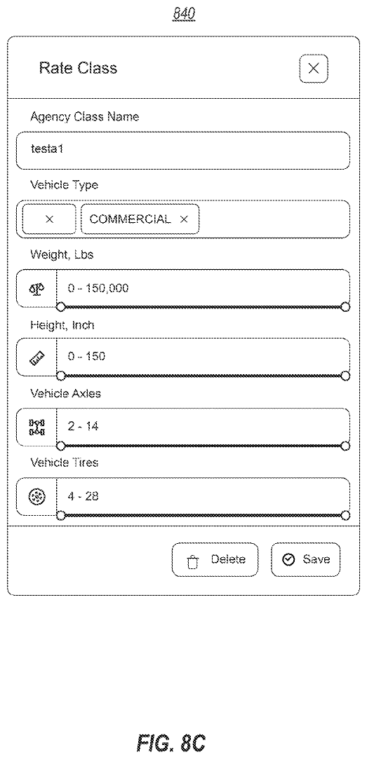

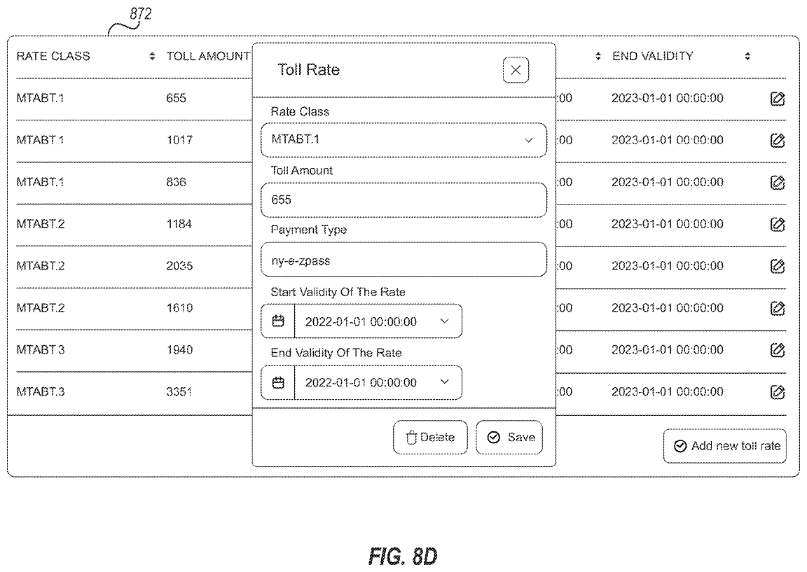

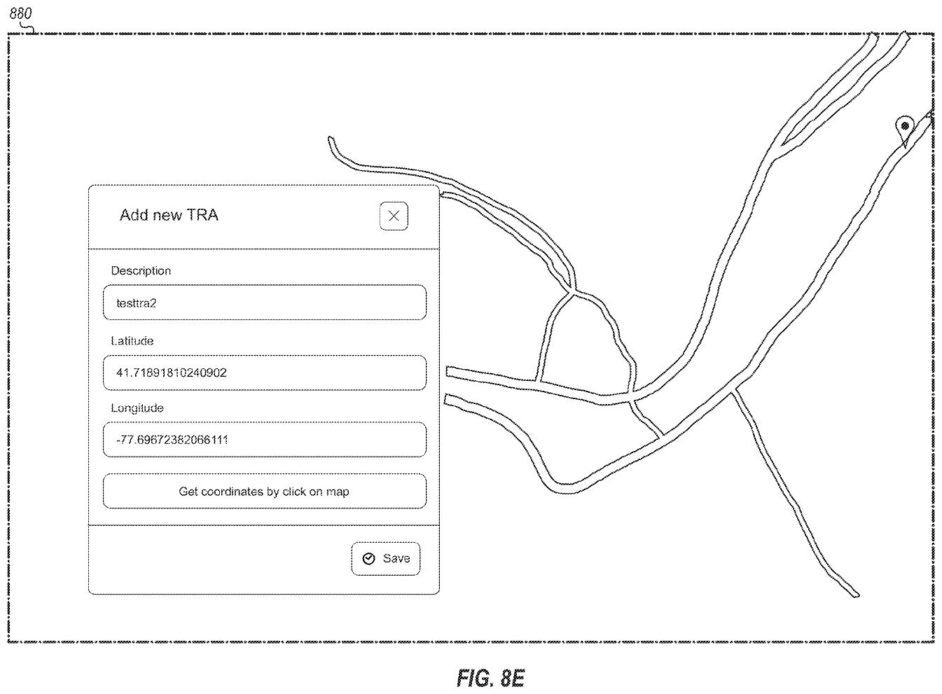

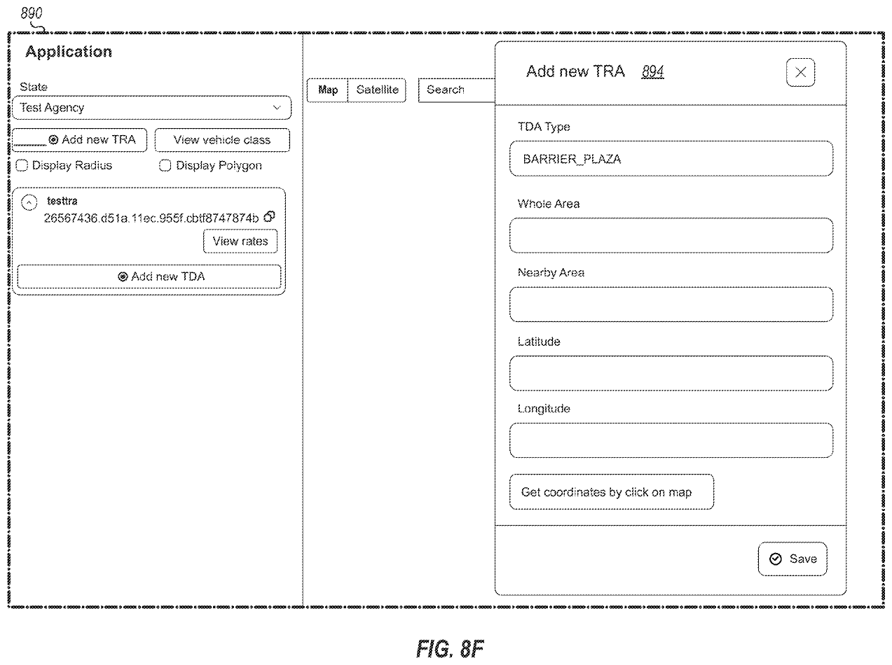

The toll rate data is further augmented/supplemented with integrated sensor checkpoint data which is used to map the different sensor checkpoints managed by different toll agencies into a single environment. System 300 provides for interface 192 which is configured to allow users to upload sensor checkpoint data and generate an integrated sensor checkpoint map (see FIG. 7, FIGS. 8A-8f and corresponding description, herein).

In some states and/or countries, there are multiple toll agencies that own and operate different tolled infrastructure including roads, highways, and bridges which have different sensor checkpoints along the different routes. Thus, the integrated sensor checkpoint map comprises information from each of the toll agencies.

In some embodiments, the integrated sensor checkpoint map is a dataset comprising data points that identify the relative positioning of the different elements associated with each toll agency's infrastructure. For example, the dataset could be stored as a relational database comprising multiple tables that, in some instances, reference overlapping data (i.e., if two or more toll agencies have similar or overlapping infrastructure elements). The relational database is configured such that a user or computer system can submit a query against the database and retrieve data about one or more of the toll agencies (e.g., a query for a location of a checkpoint, the length/duration of a tolled road along a route, a toll rate fee at a particular time of day, etc.).

In some embodiments, the integrated sensor checkpoint map is configured in a data index form, either as a back-end database that can be referenced and queried for subsequent downstream tasks and applications or in a data index form that is visually represented by tables and/or graphs. In such embodiments, a user interface is configured to display the integrated sensor checkpoint map using different identifiers that can be selected. The data index can then be filtered, refined, and/or narrowed based on the different identifiers that have been selected.

Additionally, or alternatively, the integrated sensor checkpoint map is configured to be displayed to a user in a visual mapping format, with the different toll agency infrastructure elements represented in a relational graphic format and/or where the different infrastructure elements are represented by identifiers overlayed on a geographic map of a region. In this manner, a user and/or a computer system is/are able to access data from a plurality of different toll agencies.

This data can be used to provide toll transaction data and/or augment other toll transaction data which is then subsequently correlated with telematic data obtained for one or more vehicles. Using the integrated sensor checkpoint map, the system is able to map (i.e., correlate/relate) a predicted or historic trip of a vehicle onto the integrated sensor checkpoint map and identify the portions of the trip that would have incurred toll fees.

Based on the data retrieval, the system is able to predict a toll bill associated with the vehicle's trip. This predicted toll bill can then be automatically compared against the actual toll bill received from one or more toll agencies (e.g., an electronic format of the bill, as received, and/or as scanned into an electronic record) and which is parsed and saved into the relational database tables. If there are differences between the predicted and actual bill, a customer and/or fleet manager can determine if the differences are errors and begin the dispute process with the toll agency. This is an improvement over conventional systems which do not allow users to access data about multiple toll agencies in a single location/related database while also accessing trip data comprising telematics and toll transactions from one or more toll agencies.

Overall, system 100 is representative of and/or provides functionality for disclosed embodiments which are beneficially directed to obtaining telematic data for one or more vehicles of a fleet and pairing that telematic data with toll transaction data to perform a variety of downstream tasks. These downstream tasks can be categorized into pre-trip analytics, en route trip analytics, and post-trip analytics.

### Pre-Trip Analytics

Pre-trip analytics refers to correlating future telematic data against predicted toll transaction data, or historic telematic data with predicted toll transaction data. For example, a user may wish to run pre-trip analytics to generate a predicted net toll value for a particular vehicle and trip. The system is able to predict a route based on the start destination and stop destination of the trip, including any designated stops between the start destination and stop destination. The system is able to generate a predicted route using tolled infrastructure and a predicted route using the non-tolled infrastructure. Additionally, or alternatively, the system is configured to generate a predicted route that includes both tolled and non-tolled infrastructure portions. The system is then configured to generate a predicted toll bill for each of the different tolled, partially tolled, and non-tolled routes. The system takes into consideration the vehicle class and vehicle weight to avoid infrastructure routes that are prohibited to different vehicle classes/weights, as well as includes any weigh station or customs stops. The system is also able to predict the timing/location of any refueling stops that will need to be taken during the trip and/or any other types of maintenance stops. The system may also include rest stops for the driver based on evaluating the safety of the driver and the length of shifts.

Along with the predicted route for the trip, the system is configured to generate a predicted total time, including interval time between designated stops, which is associated with the trip. The system is configured to include any predicted delays due to traffic (e.g., accidents, increased volume of cars, and/or construction) and/or inclement weather. The system is also configured to generate predicted fuel costs and an amount of wear and tear on the vehicle (e.g., tire tread, mechanical wear, mileage added, etc.). In some instances, the amount of wear and tear is calculated as a percentage of the total lifetime of the vehicle and/or a monetary amount and/or depreciation of vehicle value. Thus, the system is able to calculate a cost (e.g., time and/or money cost). In some instances, the system is configured to include cost-benefit for deliveries made on time and/or an increase in deliveries made. Additionally, the system is configured to include a cost penalty for deliveries made late on the trip and/or a decrease in the number of deliveries.

The system is configured to generate the predicted toll bill based on one or more different methods. In some instances, the predicted toll bill is based on historic toll transaction data that has been recorded based on one or more toll bills received for the vehicle on the same or similar trip as the predicted route (e.g., same, or similar start destination and stop destination and/or designated intermediary stops) in the past. The toll bill(s) could also be retrieved and analyzed for a different, but similar vehicle on the same or similar trip.

Additionally, or alternatively, the predicted toll bill is generated based on the integrated toll agency sensor checkpoint database which comprises toll checkpoints and toll rates for one or more different toll agencies. The toll bill is also configured to be generated from information obtained from a particular toll agency using the toll agency's API or other data retrieval method. In some instances, the system is configured to perform a check to ensure it has the most up-to-date information stored, wherein if it determines that the information is out-of-date, the system is configured to obtain updated toll agency information. Furthermore, in some instances, the data received by the system is normalized according to the ETL process prior to being analyzed.

After accessing the toll agency data, the system is able to determine which toll checkpoints (or tolled distances) the vehicle would pass through during the predicted route and calculate the predicted toll bill based on the toll rates corresponding to the toll checkpoints or tolled distances, taking into consideration any variable toll rate schedules based on the vehicle class, vehicle weight, and/or time of day or year. Thus, the system is able to generate a predicted toll bill for each of the different predicted routes for the trip.

In some instances, the system is configured to receive user input defining one or more optimization parameters or metrics by which to determine which predicted route should be suggested to the user. Some example optimization parameters include minimizing time, minimizing cost (e.g., based on gas costs, toll costs, etc.), minimizing wear and tear, and so forth. Thus, in such instances, the system is configured to return the predicted route that provides the greatest optimization for one or more of the user-selected parameters. Alternatively, the system is configured to generate an alert or rating associated with each predicted route based on which parameter is best optimized by each predicted route.

Furthermore, by correlating the telematic data (in this case predicted telematic data) with the toll transaction data (either historical or predicted), the system is able to evaluate a net toll value for the trip. Additionally, the system is configured to evaluate a net toll value for a set of trips associated with a particular vehicle and/or a set of trips associated with a vehicle fleet using the methods described herein. Fleet administrators are then able to determine which tolls are worth the toll fees in terms of overall operational benefits and which tolls do not provide a positive net value.

### Pre-Violations

Because the disclosed embodiments are directed to systems and methods which are able to use telematics data along with the toll transaction data, a fleet management company using an improved fleet management system, such as fleet management system 300, will be able to predict if any violations might have been incurred in previous routes and reach out to their customers to see if any vehicle-based violations were received. In this manner, the fleet management company is able to obtain violations early on for analysis and resolution, without having violations stack up over time. Additionally, the fleet management system 100 is able to analyze previous violations and predict if future violations (e.g., pre-violations 110) will be incurred and suggest preventive steps that a customer can take in order to mitigate the circumstances causing the violation, which would, in turn, reduce the number of future violations. This helps prevent violations from stacking up over time, especially if it is the same source causing the violation.

In one example, a truck may be equipped with a transponder that has become faulty such that it no longer is able to be read by the various sensor checkpoints of the tolled route. In some cases, the driver would not be able to know that the transponder is not being read and could go on for days or weeks driving the tolled routes without realizing that the transponder is not working. In such cases, the tolling agency would issue a violation for each time the driver passed through a sensor checkpoint when the transponder would not read because the tolling agency would not know that there is a correctly registered and installed transponder inside the driver's vehicle. Thus, the tolling agency would have to issue many violations over time for each instance the transponder did not read. However, by comparing the toll transaction data, and any initial violations, against the telematics data of the driver/vehicle, users are able to identify early on which circumstances are causing the violation. In the faulty transponder example, the user could be alerted to the violation of the unread transponder, investigate the transponder, and replace or fix the transponder within a short period of time of receiving the first violation. In this manner, users are able to prevent future violations from occurring from the same or related source of the initial violation.

### En Route Trip Analytics

After a driver has commenced a trip, the system is configured to dynamically update route analytics and suggestions based on new or changing information. In this manner, the system is configured to correlate toll transaction data with updated route data and/or new toll transaction data with updated route data. For example, the system is configured to suggest a re-routing of one or more vehicles based on weather, traffic, new toll fee data, notification of a violation, warning of a pre-violation, or other factors disclosed about pre-trip analytics. For example, if new toll fee data is retrieved that would produce a negative net toll value, the system is configured to re-route the vehicle such that the net toll value is less negative, neutral, and/or positive. In some instances, if the system detects a previous violation and/or predicts a pre-violation, the system is configured to identify the source of the violation and/or prompt the driver or fleet manager to investigate different possible sources of the violation. If the source cannot be fixed in order to stop the violations (e.g., fix or replace a broken transponder), the system is configured to route the vehicle(s) such that no further violations are incurred (e.g., in the case of a broken transponder, avoiding tolled roads).

### Post-Trip Analytics

After a single trip or a series of trips for a particle vehicle, or a history of trips for a vehicle fleet, the system is configured to perform various post-trip analytics. For example, the system is configured to generate a correlated dataset of historic telematic data and toll transaction data. Based on this correlation, the system is able to identify and manage violations, predict pre-violations, identify discrepancies, determine errors, prepare, manage, and file disputes based on bill errors, as well as manage tag distribution. The system is also configured to generate a report on the net toll value for a vehicle, fleet, or across multiple fleets.

### Linking Multiple Legs of a Trip

In some instances, certain sets of telematic data may need to be correlated and combined prior to comparing and correlating with toll transaction data. For example, some systems may identify multiple trips or trip routes within a set of telematic data received by the computing system. The set of telematic data is then divided into multiple subsets of telematic data, each subset corresponding to a particular trip. However, in some instances, when the subset of the telematic data is correlated to the toll transaction data, the correlated trip dataset may be missing an entry or exit toll transaction data point. This can occur if a driver has stopped on a trip route but has not exited the toll road.

For example, many toll roads are of such lengths that drivers are required to take mandatory breaks by law or, alternatively, may elect to take a break. However, sometimes these breaks can be an overnight stay some distance off the toll road. The system, based on either a timed-out logic step for non-movement of the vehicle, detected using the telematic tracking system of the vehicle, or mismatched timestamps (i.e., where trips usually occur on the same day, some trips may automatically be ended within the system if a driver stops driving one day and then begins driving the next day).

In order to solve this problem of truncated telematic datasets, systems are configured to identify different subsets of telematic data that correspond to the same trip, for purposes of correlating to toll transaction data. For example, while a vehicle may not be moving for a prolonged period of time, systems are able to identify that the vehicle stayed within a predetermined range of the toll road and continue to collect the telematic data for the same trip designation. Systems are also configured to access toll road maps and can identify whether there was an exit from the toll road available prior to the previously expected/recorded toll booth exit.

Once one or more telematic datasets are linked together to represent a complete trip, the combined telematic dataset can then be used by the system to identify the correlating toll transaction dataset. Additionally, by providing a complete telematic dataset for a particular trip, systems are able to predict the toll bill more accurately for the particular trip. These further aids the system in identifying errors between the predicted toll bill and the actual toll transactions. In some instances, the telematic datasets are combined after having been correlated to different toll transaction data points. In such instances, systems are able to identify correlated datasets that do not have corresponding entry and exit toll transactions.

A further benefit of predicting toll bills based on telematic data is the increased efficiency in customers being able to submit reimbursement requests to companies. For example, in some instances, customers are able to be reimbursed for certain trip costs, including toll bills. Companies with such policies typically require customers to submit reimbursement requests within a certain time frame. However, by the time customers receive the toll bills, the deadline for reimbursement requests has typically already passed. Thus, by providing the embodiments described herein, the user experience is improved by providing improved and faster access to the toll transaction data for their trips. For example, customers can access their telematic data, along with the predicted toll bill, for their different trips. Systems are configured, in some instances, to automatically generate a reimbursement request form using the telematic data and predicted toll bill information.

### Violations

In the case of violations, violations 114 are sent to the fleet management support and operations 118. Additionally, or alternatively, some violations (e.g., violations 114) are associated with individual vehicles and are sent to the owner of record of the vehicle. In such cases, the toll agency company may send the violations (e.g., the customer received violations 128) directly to the customer, bypassing the customer's hired fleet management company. Oftentimes, these violations stack up over time, at which point the company may send the fleet management company months' worth of violations. It is highly inefficient to go through and dispute any individual violation and so customers are typically left with trying to negotiate a reduced lump sum of money in order to take care of the violation history. In order to mitigate this situation, the fleet management system 300 is configured to allow customers 122 to send customer-received violations 126 to fleet management services 130 via the customer portal 132.

In this manner, customers 122 are able to upload information about their customer-received violations 126 so that these violations can be added to the violations database 154 which comprises violations that have been sent to the customer and/or to the fleet manager. Thus, system 300 is configured to store and access a combined list of violations. This is an improvement over conventional violation management processes in that system 300 is able to access and analyze a complete record of violations. The system 300 is better able to analyze violations for accuracy (e.g., whether the violation was improperly cited or not), identify duplicate violations, consolidate violations for lump-sum negotiating, prevent customers and fleet managers from missing violations, and use the violations to identify pre-violations (i.e., predict future violations). Furthermore, the gathered telematic data is able to not just identify errors in violations, but also provide evidentiary support to present to the toll agency for why the violations are erroneous.

### Disputes

Toll agencies typically only send the total toll bill for a particular time period and vehicle or fleet of vehicles. Similarly, violation bills typically only state the fees owed for one or more violations. Because of this, it is very difficult for customers, or their fleet managers, to identify errors in the toll bills or violations. However, disclosed embodiments provide for methods and systems that are configured to collect telemetric data for one or more vehicles in the customer's vehicle fleet and compare that telemetric data against the toll bill. Based on the telemetric data, the system is able to predict what the toll bill should have been based on the toll route and toll fee schedule. After predicting what the toll bill should have been, the system compares that to the toll bill received from the respective tolling agency.

If there is a discrepancy between the system's prediction and the actual toll bill, the system flags the bill, or particular fee line, of the bill. The customer, or fleet manager, is then able to file a dispute with the toll agency. Because of this pairing of telemetric data with toll transaction data, the disclosed embodiments beneficially provide an efficient and accurate way to identify errors in the bills and violations, file disputes (e.g., disputes 116), and provide evidence for why the dispute should be resolved. This is a significant improvement over conventional fleet management systems which only provide the toll bill information without an efficient and accurate way to identify and investigate errors in the toll bills.

### Error Mitigation

There are many different types of errors in bills and violations that the system is able to identify. One bill error that occurs is double billing. For example, at some sensor checkpoints, the checkpoint is equipped with sensors that are configured to record the tag or transponder and sensors that are configured to record the license plate of the vehicle. When a vehicle with the right tag or transponder passes through the sensor checkpoint, one or more sensors should read only the tag or transponder and should not record the license plate (or rather should not charge a toll fee based on the license plate, but only charge a toll fee based on reading the tag/transponder).

However, in some circumstances, the sensor checkpoint malfunctions and records both a toll fee based on the tag and a toll fee based on the license plate. However, the toll bill will often only show the total charges owed. Thus, by comparing the telemetric data against the toll bill information, the system is configured to identify potential double billings. This is especially important when the toll fee associated with the tag is typically represented in the toll bill sent to the customer's fleet manager, while the toll fee associated with the license plate is often sent directly to the customer. This is because the license plate is registered to the customer, not to the fleet manager. In such cases, the toll agency would not be able to easily make the connection between the license plate and the fleet manager. This process further compounds the difficulty in identifying double billing. Thus, the disclosed embodiments beneficially provide systems and methods for identifying errors in the bills, such as double-billing, wherein the customer or customer's fleet manager is able to file a dispute based on the identified error using the paired telemetric-toll transaction dataset.

In some instances, drivers are transporting multiple-linked vehicles, such as a truck hauling one or more trailers. In such instances, the trailer may separately incur toll bills from the truck, leading to incorrect double billing. For example, a truck may have a transponder that is read at the toll booth, while the trailer may have a license plate that is also read at the toll booth. One additional complication is that the timestamp for each of the truck and the trailer toll bills may not be an exact match since the trailer will be passing through the toll booth slightly later than the truck (where the transponder resides). Systems and methods provided herein facilitate a way to identify incorrect double billing for multiple-linked vehicles. For example, in some instances, the truck and the trailer are each equipped with a telematics tracking system. In such instances, the telematic data for the truck and the telematic data for the trailer can be correlated with each other. In this manner, systems can determine that truck and trailer are linked and trigger an alert in the system if multiple bills are detected for that multiple-linked vehicle.

In another example, only the truck may be equipped with a telematic tracking system. Thus, in order to correlate data from the truck to a particular trailer, systems access a look-up table with trailer license plate information, and which truck the trailer was assigned to during a particular trip. In this manner, systems can check to see if the truck's transponder incurred a toll bill, as well as whether the trailer's license plate also incurred a toll bill. Customers can then dispute this double billing. This look-up table can either be created/generated by a truck driver who inputs the trailer license plate information into the look-up table at some point during his or her drive. Alternatively, systems are configured to access a third-party database (e.g., through an API to the third-party site) associated with the trailer owner/manager and identify which trailers have been assigned to which trucks. In some instances, the assignment is detected based on a shared trip date, a shared starting and/or ending location, or an explicitly recorded assignment.

### Tags/Tag Procurement

Each toll agency 104 manages a system and infrastructure of tolled roads/highways and a network of toll sensor checkpoints. At these checkpoints, the toll sensors read the tag or transponder installed on a vehicle or read the license plate, when there is not a readable tag. Each vehicle in a vehicle fleet is equipped with a particular tag (e.g., tags/fleet 112) from a toll agency. The toll agency typically has a headquarters in the state from which the tags are based. Additionally, each toll agency has a different fee structure based on the number of tags ordered and used within a fleet. For example, typically, the more vehicles (and thus tags) in a vehicle fleet, some toll agencies provide a better discount rate on the set of tags.

The telemetric data collected for the vehicle fleet will show the routes for each vehicle in the fleet. Based on the telemetric data and the tag fee structure associated with different tag regions, the system 300 is configured to optimize tag procurement and assignment in order to maximize savings for a particular customer, or across a set of customers.

For example, the fleet manager may manage multiple fleets for different customers. In this case, the system can determine what the best originating state is for the set of vehicles across multiple fleets. In this manner, the system maximizes the discount based on the number of tags across multiple fleets, wherein each customer is reaping the benefit of lower tag fees because, in effect, their fleet has been “combined” with one or more additional fleets. The system is also configured to determine how to split up the set of vehicles comprising vehicles from multiple fleets in order to best maximize the cost savings. Thus, the disclosed embodiments are beneficially directed to systems and methods which are configured to predict/suggest which set of tags to use, from which originating state to buy the tags, and which vehicles should be assigned which tags in order to maximize monetary savings.

Attention will now be directed to FIG. 3, which illustrates a computing environment comprising computing systems that include and/or that may be used to implement aspects of the claimed invention. As shown, the computing environment 300 includes an application computing system 310 in communication with at least one remote system 320 through network connections 330. The network connection 330 may include any combination of wired and wireless connections. Each of the application computing system 310 and/or the remote computing system 320 may be stand-alone devices. They may also each comprises distributed computing systems with any of the computing components described in reference to the computing systems being distributed among two or more separate computers or computing systems, whether locally or remotely located from each other.

Each of the computing systems also includes one or more hardware processor(s), user interface(s), I/O devices, and hardware storage device(s). The hardware storage devices store computer-executable instructions that are executable by the corresponding hardware processor(s) to implement the disclosed methods and functionality described herein.

For example, computer-executable instructions are stored that are configured to cause the computing system(s) to generate correlated trip datasets comprising normalized toll transaction data and normalized telematic data, as well as generate a net present toll value configured to indicate whether the tolled route, along with its associated toll fees. This net present toll value can then be compared against a net present toll value threshold, wherein the system determines whether the net present toll value meets or exceeds a net present toll value threshold. If the net present toll value meets or exceeds the net present toll value threshold, the system is configured to generate a recommendation to continue using the various tolls. However, if the net present toll value does not at least meet the net present toll value threshold, the system is configured to generate a recommendation to discontinue the use of one or more tolls that had been previously used.

By configuring the system in this manner, the system is able to improve the user experience by identifying specific tolls or a plurality of tolls that are worthwhile to a customer vs. those tolls which are not beneficial to a customer based on one or more different criteria (e.g., criteria such as time savings, monetary savings, driver safety, vehicle wear, and tear, etc.). Thus, in some instances, the net present toll value is a net present value of time, where the system optimizes the routes based on the greatest reduction in time and identifies which tolls or tolled portions of the route will lead to the greatest reduction in time.

The computing system(s) are further configured to determine whether one or more vehicle tags should be reassigned based on monetary savings and reassign one or more vehicle tags as part of vehicle tag procurement and management. The system(s) is also configured to generate one or more error alerts when the system finds discrepancies and errors in the toll transaction data based on comparing the toll transaction data to the telematic data. The computing system(s) is further configured to identify abuse and fraud in vehicle fleets.

The referenced user interfaces may include application interfaces and/or user portals that receive user input (e.g., search queries, trip preferences, activity information, user profile information, etc.) that is entered at an I/O device (e.g., keyboard, mouse, touch screen, microphone, etc.) and that present/display or otherwise render information, such as toll transaction data, fleet data, and/or telematic data, to a user on a computer display screen or other I/O device (e.g., phone screen, speaker, haptic feedback device, headset display, etc.).

The user interfaces are configured to display a plurality of selectable icons within the display of the user interface. As a note to the use of “icon” herein, it should be appreciated that icon refers to a visual representation of an interface item that is configured to be selectively operational, such that whenever the icon is selected, it is configured to cause a particular function within the application (e.g., displaying a new application page and/or generating an integrated toll agency information database).

### User Portal Interface(s)

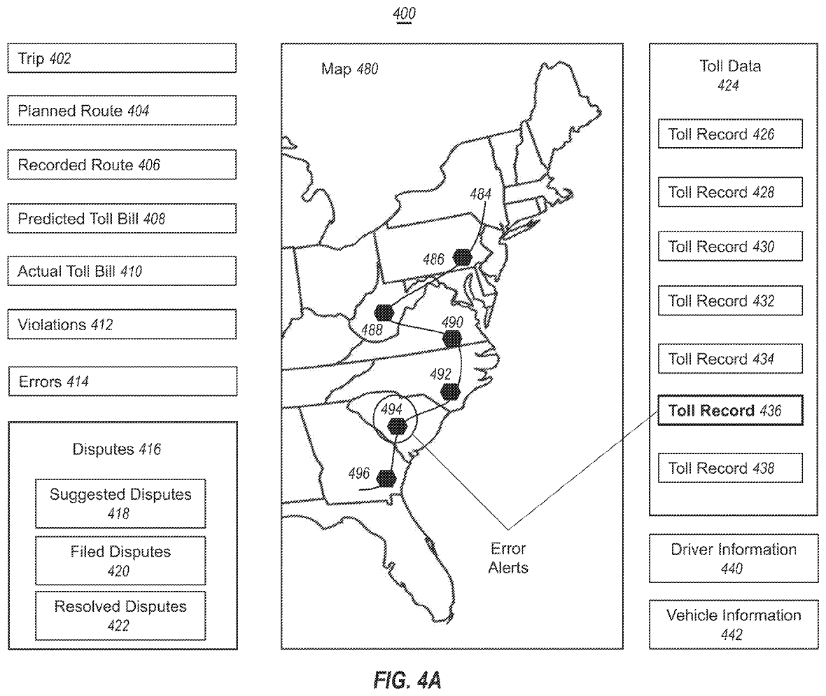

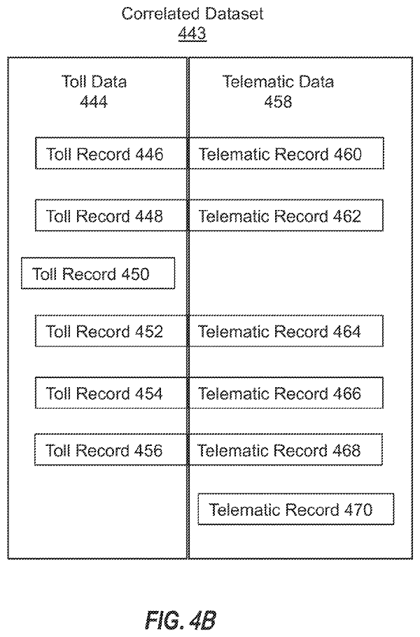

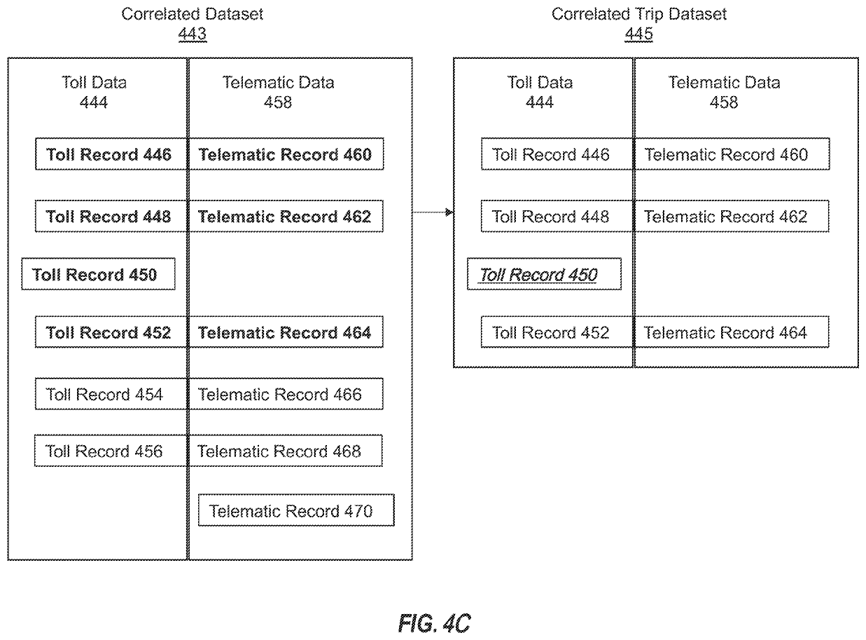

Attention will now be directed to FIG. 4A, which illustrates an example user interface, or user portal 400, which is configured to provide a user with trip information, analytics reports, and other fleet management tools. It should be appreciated that user portal 400 is representative of various user portals, including a fleet manager portal, an administrator portal, a customer portal, and/or a driver portal.

For example, user portal 400 is configured to allow a user to select a particular trip from a plurality of historical and planned trips (e.g., trip 402). The trip 402, in this illustration, is a historical trip (i.e., a trip that has been completed). Trip 402 is associated with a planned route 404, which was the route initially projected for the trip, as well as the recorded route 406 which is the GPS data for the actual route taken by a particular vehicle for that trip. Trip 402 is also associated with a predicted toll bill 408, which is the toll bill that was initially projected for the trip based on the planned route 404. Additionally, or alternatively, the predicted toll bill 408 is based on the recorded route 406. The user is also able to access the actual toll bill 410 once it has been generated and transmitted by the toll agency. The user is also able to access any violations 412 which have been received in conjunction with the illustrated trip 402.

After analyzing and comparing the different datasets (e.g., predicted toll bill 408 against the actual toll bill 410), the system determines whether there are any differences or discrepancies between the two toll bills. If there are no discrepancies, the system prompts the user to pay the toll bill. If there are discrepancies, the system (e.g., system 300) further analyzes the toll bills, as well as the route data, in order to determine if the discrepancies are errors made by the toll agency. If the errors are determined to be or predicted to be actual errors (e.g., errors 414), the user is directed to a dispute management system (e.g., disputes 416). The dispute management system allows a user to track disputes, including receiving suggested disputes 418 (i.e., disputes on errors identified by the system that the user should file), filed disputes 420 (i.e., disputes that have been filed with the toll agency), and resolved disputes 422 (i.e., disputes that have been resolved). Disputes can be resolved in different ways, including determining that the discrepancy was based on faulty data and thus should be amended in toll bill 410 or determining that the discrepancy was not an error in the toll bill 410 and the toll bill 410 should not be amended.

When a user selects a particular trip, it is displayed in various manners. For example, in some instances, the user portal 400 is configured to display the trip information on a map interface 480. The map interface 480 is generated based on the integrated toll sensor checkpoint dataset, as well as the recorded route 406 which is visually represented by a continuous route line 484. Map 480 is also configured to indicate what weather conditions were like, timestamps along the route, any delays incurred, traffic conditions, maintenance performed, vehicle/cargo inspections, weigh stations, etc. Additionally, or alternatively, the user portal 400 is configured to display the trip information in a list format (e.g., toll data 424). The toll data 424 shows a list of toll record entries which each correspond to a particular sensor checkpoint on the map.

For example, toll record 426 corresponds to sensor checkpoint 486, toll record 428 corresponds to sensor checkpoint 488, toll record 430 corresponds to sensor checkpoint 490, toll record 432 corresponds to sensor checkpoint 492, toll record 434 corresponds to sensor checkpoint 494, and toll record 438 corresponds to sensor checkpoint 496. The user portal 400 also displays additional information such as driver information 440 and vehicle information 442.

The user portal 400 is also configured to display potential or confirmed errors in the toll data 424 in a flagged format (e.g., bolding in toll record 436). In this case, toll record 436 corresponds to sensor checkpoint 454, in addition to toll record 434. The system identified this error, which is a double-billing error. This would result in a suggested dispute 418 being generated which can be reviewed and approved/denied by the user prior to filing and/or prior to a dispute being automatically filed In some embodiments, a dispute notification is automatically generated and transmitted to the billing and tolling agency in response to detecting a single error or a pre-determined number of errors (e.g., two-ten errors, or more than ten errors). In some instances, the dispute notification comprises an electronic record. In other instances, the dispute notification comprises a physical letter. The dispute notification will, in some instances, include evidence that identifies the error in the bill and/or violation, in some instances, the client and/or administrator is notified whenever a dispute notification is generated and/or prior to transmitting the dispute notification. It should be appreciated that the automatically filed dispute will be tailored to the individual tolling agency dispute resolution processes.

Attention will now be directed to FIG. 4B, which illustrates a user interface displaying a correlated dataset 443. For example, a set of toll data 444 (e.g., toll transaction data) has been correlated to a set of telematic data 458. Toll Data 444 comprises a plurality of toll transaction data points or toll records (e.g., toll record 446, toll record 448, toll record 450, toll record 452, toll record 454, and toll record 456). Telematic data 458 comprises a plurality of telematic data points or telematic records (e.g., telematic record 460, telematic record 462, telematic record 464, telematic record 466, telematic record 468, and telematic record 470).

Using systems and methods described herein, different data points in the toll data 444 and the telematic data 458 have been correlated to each other. For example, toll record 446 is correlated to telematic record 460, toll record 448 is correlated to telematic record 462, toll record 452 is correlated to telematic record 464, toll record 454 is correlated to telematic record 466, and toll record 456 is correlated to telematic record 468.

In some, not all data points from either dataset are found to be correlated. For example, toll record 450 does not have a corresponding data point in the telematic data 458. Similarly, telematic record 470 does not have a corresponding data point in the toll data 444. Such discrepancies between the datasets allow the system to identify possible errors in either dataset or alert a system user (e.g., fleet manager) for further investigation.

Additionally, each of the correlated data point pairs may be associated with a particular confidence rating. For example, each data point comprises a set of characteristics. If the toll data point is determined to share a certain number of characteristics that meets or exceeds a confidence threshold, the data points are determined to be correlated (e.g., a correlation link is generated for the data point pair). However, if the confidence threshold is not met, the system generates an alert that while some characteristics are shared between the data points, some characteristics are not shared. For example, the timestamp might match but the geographic location might not match. This is another example of the system being able to identify errors in the data and alert a system user.

Attention will now be directed to FIG. 4C, which illustrates a user interface displaying a correlated trip dataset. Using the correlated dataset 443 described in FIG. 4B, systems are able to identify a subset of the toll data points and a subset of the telematic data points that correspond to the same trip. The system is then able to generate a correlated trip dataset specifically for that trip. For example, correlated trip dataset 445 comprises toll data 444 and telematic data 458. However, toll data 44 comprises toll record 446, toll record 448, toll record 450, and toll record 452. Telematic data 458 comprises telematic record 460, telematic record 462, and telematic record 464.

It should be appreciated that some user interfaces are configured to format records to alert a user that a potential error has been detected. For example, toll record 450 does not have a corresponding telematic record and so the user interface has been updated to display toll record 450 in a different formatting (e.g., bolding, italics, underlining) than the other corresponding record pairs (e.g., regular typeface).

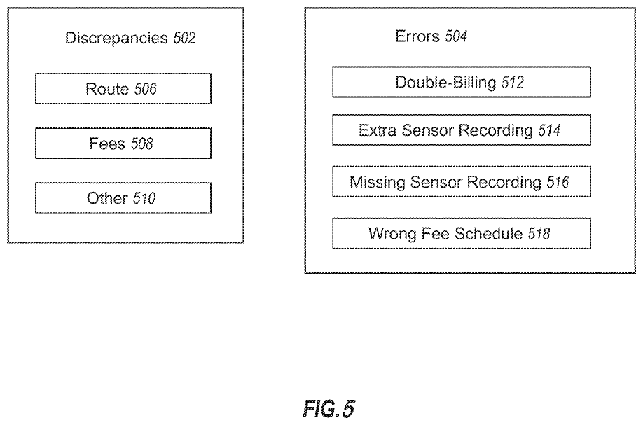

Attention will now be directed to FIG. 5, which illustrates various examples of discrepancies 502 and errors 504 that the system is configured to identify. For example, the system may find route discrepancies 506, fee discrepancies 508, or other discrepancies 510. The route discrepancies 506 may be differences between the planned route and the recorded route. The fee discrepancies 508 may be differences between the predicted toll bill and the actual toll bill or between the toll transaction data and the violations. These differences are analyzed, and the system predicts a source of the difference, whether the difference is due to the system's own analytics or source data, or whether the difference is due to an error made by the toll agency. If the difference is due to the system's own analytics, then the system is configured to perform self-analysis to determine where the system should be updated in order to mirror the accurate toll transaction data. For example, the system may have obtained the wrong or outdated fee schedule (e.g., error 518), wherein the fee schedule for that toll agency will be updated with the correct fee schedule in order to improve the toll bill prediction.

However, if the difference is due to an error made by the toll agency, the system flags the discrepancy as an error and determines what type of error has been made. Some examples of errors 504 include double-billing 512, an extra sensor recording 514 (i.e., at a checkpoint that was not passed through by the vehicle in question), and a missing sensor recording 516.

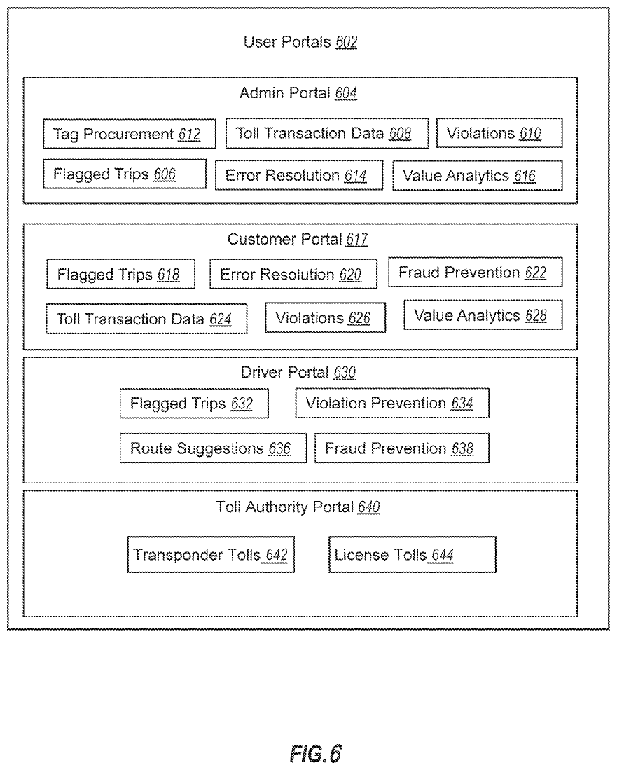

Attention will now be directed to FIG. 6, which illustrates various example embodiments of user portals 602. For example, if the user portal is configured as an admin portal 604, the portal is configured to allow a user to access various fleet management tools such as flagged trips 606, toll transaction data 608, violations 610, tag procurement 612, error resolution 614, and value analytics 616. If the user portal is configured as a customer portal 617, the portal is configured to allow a user to access flagged trips 618, error resolution 620, fraud prevention 622, toll transaction data 624, violations 626, and value analytics 628. In addition, if the portal is configured as a driver portal 630, the portal is configured to allow a user to access and update information about flagged trips 632 that have been flagged for the driver, route suggestions 636 (prior to leaving and en route of the trip), violation prevention 634 (i.e., trouble-shooting suggestions to avoid additional or new violations), and fraud prevention 638 (i.e., alerting the driver to possible theft or loss of a transponder, or another issue). If the portal is configured as a toll authority portal 640, the portal is configured to allow a user to access and update information for facilitating improved processes for sending toll bills and collecting bill payments. For example, toll authority users are provided access to transponder tolls 642 and vehicle tolls 644. Toll authority portals 640 may also comprise access to toll fee schedules, geographic information for different toll booths and toll roads, customer databases, and toll pass information, among others. Toll authority portal 640, in some instances, is also configured to display one or more different selectable icons which are operable when selected to cause the computing system to automatically generate and transmit toll bill invoices to the respective toll infrastructure users.

Such user interfaces as illustrated in FIG. 6 beneficially provide improved access, navigation, filtration, and use of the different datasets, including correlated datasets of telematic and toll transaction data. In some instances, systems are configured to track the historical activity of which portal functions are most used by a user and automatically reconfigure the user's portal to display the information and selectable icons which the user has interacted with based on increasing use or frequent use exceeding a predetermined use threshold.

Attention will now be directed to FIGS. 7A-7D and FIGS. 8A-8F, which illustrate example embodiments of flow diagrams and corresponding user interfaces configured for generating a database comprising toll agency data, including toll agency sensor checkpoints.

As shown, for example, a backend administrator is able to identify a new agency, including the name, state, and website associated with the newly identified toll agency. Users are provided user interfaces through which they can add a new agency, wherein the new agency is saved in the database (DB), as shown by “add agency in UI and local DB” 702 shown in FIG. 7A). An example of a user interface that can be used to add a new agency is shown in FIG. 8A. The system (either through automatic machine processes or user processes) obtains toll facility information, including roads, bridges, and tunnels, as well as toll pricing based on vehicle types, classes, and plaza types. Rate classes are added, for example, as shown by add/change vehicle classification 706, including other diagram components, shown in FIG. 7A. User interfaces for adding and editing rate classes are shown, for example, in FIG. 8C. After installing and starting the system program, a user interface associated with the system program is configured to allow a user to add a new toll road authority (TRA) to be stored in the database, as illustrated by step 704 in FIG. 7B. Examples of user interfaces for adding and editing TRAs are shown in FIGS. 8B, 8E, and 8F. Next, the interface is configured to allow a user to add or change vehicle classifications for toll rates.

The user interface is further configured to allow a user to add/change transportation department associations (TDAs) or government-related transportation organizations, including the location using numerical input and/or map input, add/change the TDA radius for a nearby area, add/change TDA radius for a far area, and set/change the TDA type (e.g., barrier or distance). For example, some tolls are calculated based on passing through a particular barrier, where each barrier (i.e., sensor checkpoint) is assigned a particular toll fee. Additionally, or alternatively, some tolls are calculated based on the distance driven on a tolled route. Similar user interfaces that are shown for adding and editing TRAs can also be used to add and/or edit TDAs.

Once there are no more TDAs or TRAs to add/change, the interface is configured to parse the agency's data for toll rates based on distance, link the rates with the correct TRAs and rate classes for the toll agency, and prepare datasets to be imported into the database. The interface is also configured to collect information about the barrier type TRAs, wherein the interface is configured to allow a user to select a particular barrier TRA, add/edit the toll rate record of the selected TRA, and edit the following information: rate amount, toll rate type, toll rate class, and toll rate validity time interval. Toll rate records are added and/or edited, for example, as illustrated by “add/edit toll rate record” 708, as shown in FIG. 7D. Examples of user interfaces that are configured to allow a user to add or edit a toll rate is shown in FIG. 8D.

For example, FIG. 8A illustrates a user prompt 810 for adding a new agency. FIG. 8B illustrates a user prompt 820 for adding a new TRA, including a description, latitude, and longitude. Alternatively, systems can automatically update the latitude and longitude based on a user selection of a pixel of a graphical representation of a geographical map. FIG. 8C illustrates a user prompt 840 for adding in a rate class, including the agency class name, the vehicle type, and other vehicle characteristics.

FIG. 8D illustrates a user interface 872 comprising a first window that displays a table of a toll fee schedule, including the rate class, toll amount, and starting and ending times for that particular toll amount. A second window is shown which is a user prompt that allows a user to update the table with a new toll rate, including the rate class, toll amount, payment type, and timeframe of the toll amount.

FIG. 8E illustrates a user interface including a first window 880 for displaying a geographical map and a second window configured as a user prompt to add a new TRA. FIG. 8F illustrates a user interface 890 comprising a first window for adding and viewing information for a particular agency, a second window for displaying and navigating a map, and a third window configured as a user prompt to add a new toll road authority (TRA) to the system database.

After the system determines that no other changes are needed for the TRA, the system is configured to run the SQL WB script in order to make the changeset and apply the changeset to the central database. As new toll agencies are discovered, each can be added to the database such that an integrated inter-agency sensor checkpoint dataset can be generated. The system is configured to generate a listing or map visualization of the integrated inter-agency sensor checkpoint dataset, such that a user is able to easily access and view the different toll agencies, their respective infrastructure, and corresponding toll rates. In this manner, the system is configured to receive user input and/or computer-retrieved (e.g., through web-page-based text crawling or through APIs) information about a plurality of toll agencies. This data is then used in conjunction with the telematic data of a vehicle in order to estimate/predict a toll bill for a particular trip or set of trips. This predicted toll bill can be compared against the toll bill sent by the toll agency, wherein the system is able to identify discrepancies and determine if the discrepancies are errors that need to be corrected.

The system is also configured to analyze the predicted toll bill and determine a net present value of taking the tolled routes as compared to the resources (e.g., time) predicted for non-tolled or partially tolled trips. The system analyzes the predicted toll trip vs. the predicted non-tolled trip.

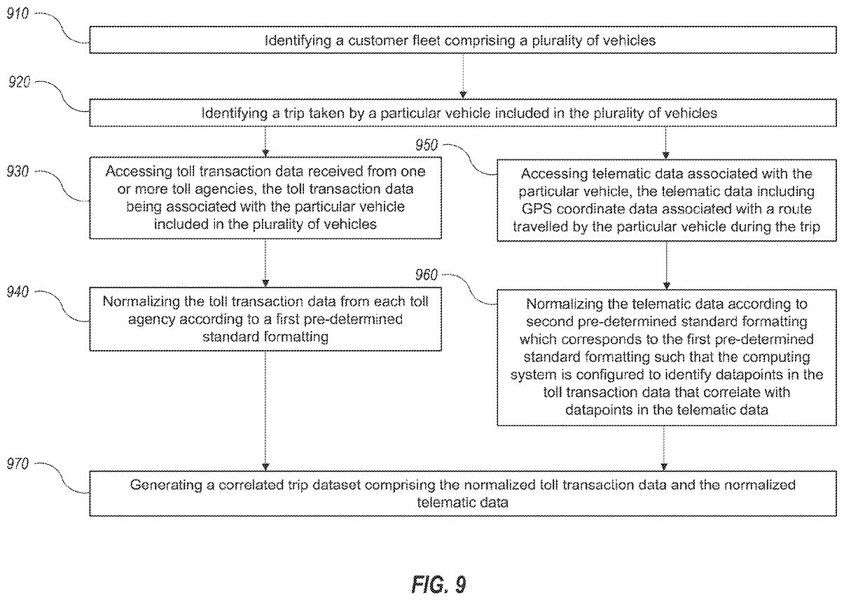

Attention will now be directed to FIG. 9, which illustrates a process flow diagram comprising a plurality of acts associated with a method for generating a correlated trip dataset comprising normalized toll transaction data and normalized telematic data. FIG. 9 illustrates a flow diagram that includes various acts (act 910, act 920, act 930, act 940, act 950, act 960, and act 970) associated with exemplary methods that can be implemented by computing system 110.

As shown in FIG. 9, the first illustrated act is directed to identifying a customer fleet comprising a plurality of vehicles (act 910). The system then identifies a trip taken by a particular vehicle included in the plurality of vehicles (act 920) and accesses toll transaction data received from one or more toll agencies (act 930). The toll transaction data is associated with the particular vehicle included in the plurality of vehicles. The toll transaction data from each toll agency is normalized according to a first pre-determined standard formatting (act 940). In addition to toll transaction data, the systems access telematic data associated with the particular vehicle (act 950). The telematic data including GPS coordinate data associated with a route traveled by the particular vehicle during the trip. The telematic data is normalized according to second pre-determined standard formatting which corresponds to the first pre-determined standard formatting such that the computing system is configured to identify data points in the toll transaction data that correlate with data points in the telematic data (act 960). Finally, the systems generate a correlated trip dataset comprising the normalized toll transaction data and the normalized telematic data (act 970).

It should be appreciated that the datasets are configured to be correlated based on one or more corresponding attributes. In some instances, a trip comprises a plurality of events (e.g., passing through a toll sensor, crossing a toll bridge, traveling a certain portion of a tolled road). Similarly, a toll bill is based on one or more events that incurred a toll fee or violation. Thus, a data point in the toll transaction data and a data point in the telematic data correlate to each other based on the data points corresponding to a similar or the same event and/or portion of the route traveled by the particular vehicle during the trip.

In some instances, the datasets are correlated based on shared events, as described above, based on matching timestamps, based on matching GPS coordinate locations, based on matching time durations, based on matching distance durations, and/or another attribute that is shared between the toll transaction data and the telematic data. The event could comprise any data communication between the vehicle (e.g., transponder) and toll agency infrastructure, between the vehicle (e.g., GPS tracker) and fleet management system, and/or between the toll agency and the fleet management system.

Thus, by correlating the datasets, a system and/or user is able to cross-reference between the two datasets and identify any differences which may be errors in the toll transaction data. This correlated dataset can be stored as a relational database that is searchable through a user interface or is able to be queried by a user and/or computing system. The correlated dataset can be visually referenced and/or can be indexed and then referenced via a query.

Additionally, the correlated trip dataset is configured to be presented to the user in an interactable table format and/or interactable map format. (See illustration of the user interface in FIG. 4). This correlated trip dataset, in any of its forms, is able to be referenced for downstream analysis and tasks (e.g., bill error analysis, violation analysis, tag management, etc.).

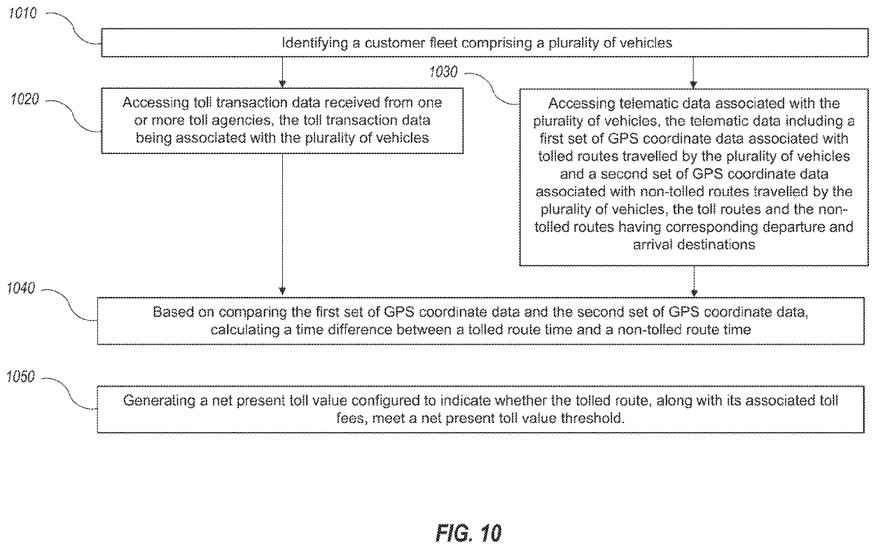

Attention will now be directed to FIG. 10, which illustrates a process flow diagram comprising a plurality of acts associated with a method for generating a net present toll value. FIG. 10 illustrates a flow diagram that includes various acts (act 1010, act 1020, act 1030, act 1040, and act 1050) associated with exemplary methods that can be implemented by computing system 110. As shown in FIG. 10, the first illustrated act is directed to identifying a customer fleet comprising a plurality of vehicles (act 910). The systems are then configured to access toll transaction data about the plurality of vehicles (act 920) and access telematic data associated with the same plurality of vehicles (930). The telematic data includes a first set of GPS coordinate data associated with tolled routes traveled by the plurality of vehicles and a second set of GPS coordinate data associated with non-tolled routes traveled by the plurality of vehicles. Based on comparing a first set of GPS coordinate data and the second set of GPS coordinate data, the systems then calculate at least a value difference between a tolled route and a non-tolled route (act 1040) and generate a net present toll value. In some instances, the system is further configured to indicate whether the tolled route, along with its associated toll fees, meets a net present toll value threshold (act 1050).

In some instances, the value difference is based on a difference calculated between one or more attributes of the tolled route vs. the non-tolled route. For example, the value difference is configurable as a time difference, wherein a first time is determined for the tolled route and a second time is determined for the non-tolled route. In such examples, the net present toll value is a net present value of time based on the time difference calculated for the different routes.

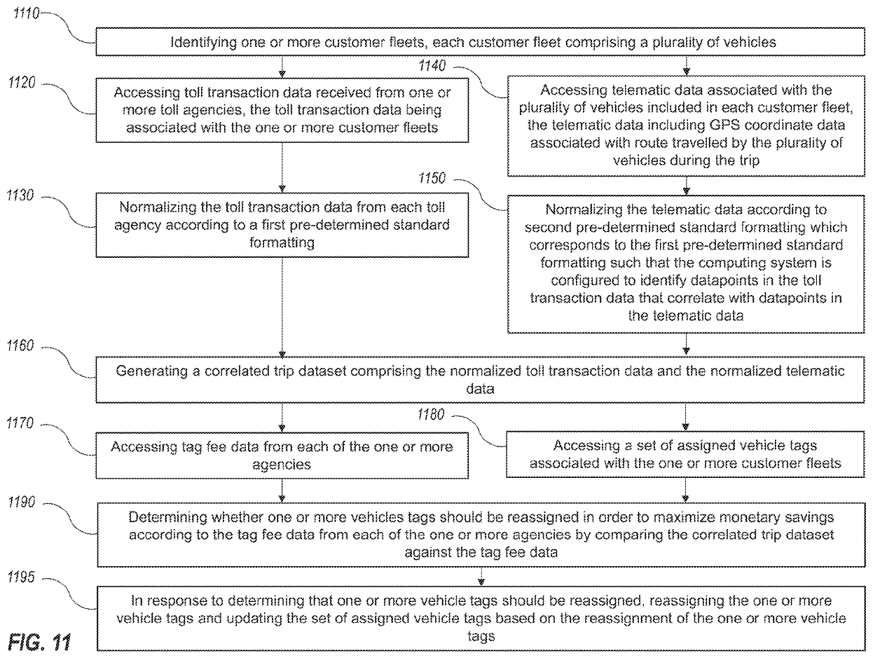

Attention will now be directed to FIG. 11, which illustrates a process flow diagram comprising a plurality of acts associated with a method for generating a net present toll value. FIG. 11 illustrates a flow diagram that includes various acts (act 1110, act 1120, act 1130, act 1140, act 1150, act 1160, act 1170, act 1180, act 1190, and act 1195) associated with exemplary methods that can be implemented by computing system 110. As shown in FIG. 11, the first six illustrated acts (act 1110, act 1120, act 1130, act 1140, act 1150, and act 1160) are directed to similar acts as shown in FIG. 9 (e.g., act 910, act 930, act 940, act 950, act 960, and act 970).

After generating the correlated trip dataset comprising the toll transaction data and the telematic data, the system is configured to access tag fee data from different toll agencies (act 1170) and access a set of assigned vehicle tags associated with one or more customer fleets (act 1180). The system then determines whether one or more vehicle tags should be reassigned in order to maximize monetary savings according to the tag fee data from each toll agency by comparing the correlated trip dataset against the tag fee data (act 1190). In response to determining that one or more vehicle tags should be reassigned, the system is configured to reassign one or more vehicle tags and update the set of assigned vehicle tags based on the reassignment of the vehicle tags (act 1195).

In some instances, license plates and license plate registrations are also used with agencies that do not have transponders. Additionally, or alternatively, license plates are used as a backup identifier for vehicles that use transponders, in the case that the transponders are broken or unavailable. Thus, in some circumstances, the tag fee data is based on transponder data, based on license plate data, or a combination of both.

In some instances, the monetary savings are based on identifying tag discounts associated with a particular tag distribution. Additionally, or alternatively, the monetary savings are further based on identifying transponder fees associated with the one or more customer fleets, such that the system is configured to compare monetary savings obtained from leveraging tag discounts against transponder fees incurred from utilizing transponders in the one or more customer fleets. For example, some agencies charge fees for the different tags and associated distribution of those tags, while some agencies have additional charges for using transponders vs. license plates for toll transaction tracking/reading. Thus, the system is able to determine net monetary savings by taking into consideration any discounts achieved by changing the tag distribution while also taking into consideration any fees incurred from using transponders and/or license plates.

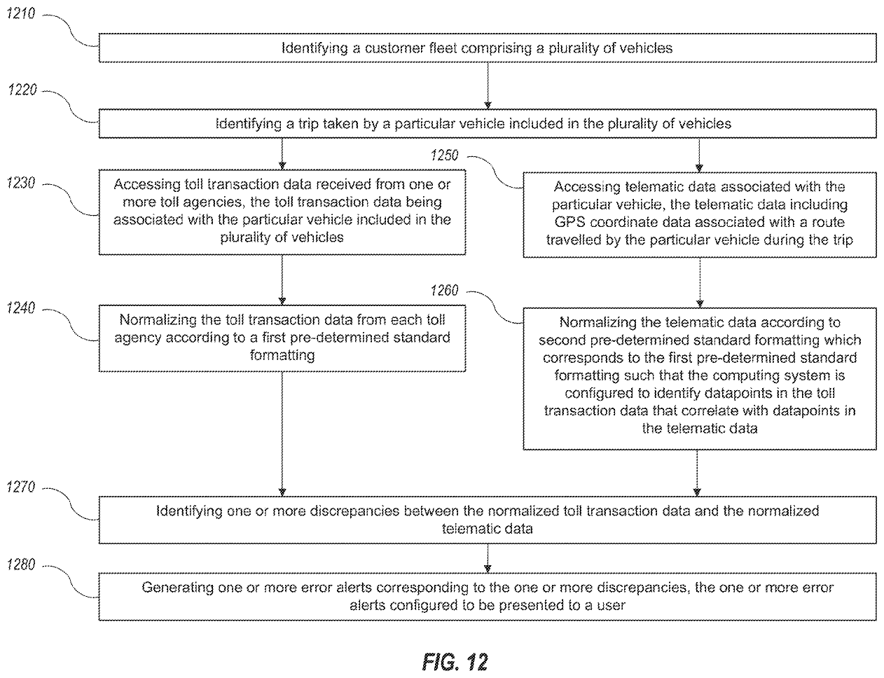

Attention will now be directed to FIG. 12, which illustrates a process flow diagram comprising a plurality of acts associated with a method for identifying errors in toll transaction data. FIG. 12 illustrates a flow diagram that includes various acts (act 1210, act 1220, act 1230, act 1240, act 1250, act 1260, act 1270, and act 1280) associated with exemplary methods that can be implemented by computing system 110. As shown in FIG. 12, the first six illustrated acts (act 1210, act 1220, act 1230, act 1240, act 1250, and act 1260) are directed to similar acts as shown in FIG. 9 (e.g., act 910, act 920, act 930, act 940, act 950, and act 960).

The system is further configured to identify one or more discrepancies between the normalized toll transaction data and the normalized telematic data (act 1270) and generate one or more error alerts corresponding to the one or more discrepancies (act 1280). One or more error alerts are configured to be presented to a user. In some instances, this includes sending the alert to an administrator and/or end user associated with the fleet/vehicle(s).

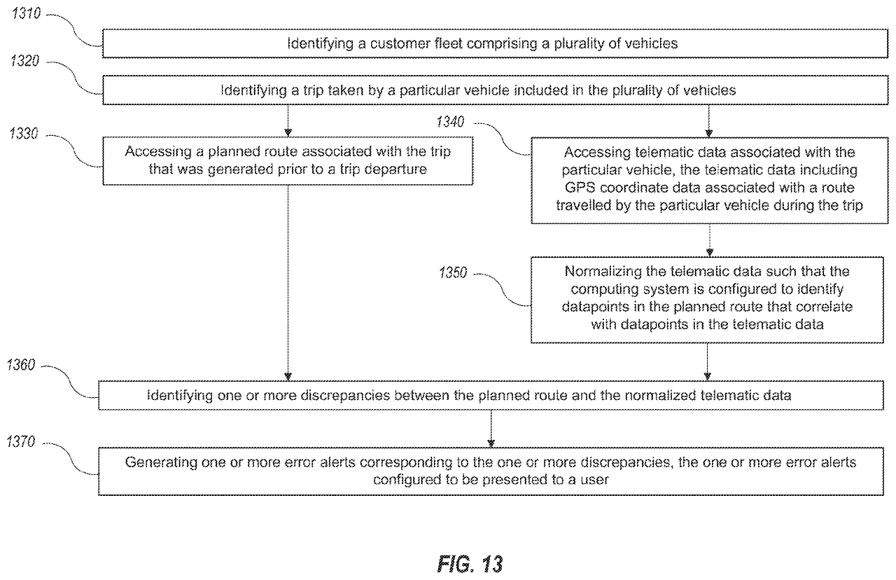

Attention will now be directed to FIG. 13, which illustrates a process flow diagram comprising a plurality of acts associated with a method for detecting abuse and fraud in vehicle fleet management. FIG. 13 illustrates a flow diagram that includes various acts (act 1310, act 1320, act 1330, act 1340, act 1350, act 1360, act 1370, and act 1380) associated with exemplary methods that can be implemented by computing system 110. As shown in FIG. 13, several acts (act 1310, act 1320, act 1340, and act 1350) are directed to similar acts as shown in FIG. 9 (e.g., act 910, act 920, act 950, and act 960). Additionally, as shown in FIG. 13, the system is further configured to access a planned route associated with the trip that was generated prior to a trip departure (Act 1330). The systems are then configured to identify one or more discrepancies between the planned route and the normalized telematic data (act 1360). If discrepancies are identified, then the system is configured to generate one or more error alerts corresponding to the discrepancies in order to alert a user (act 1370). In some instances, this includes sending the alert to an administrator and/or end user associated with the fleet/vehicle(s).

For instance, by way of example and not limitation, the disclosure includes embodiments configured for performing fraud, abuse, and violation detection based on detecting discrepancies in toll transaction data as compared to telematics data of a vehicle or fleet. Toll transaction data comprises one or more of: toll fees, toll locations, toll timestamps, toll bills, customer invoices, tag fees, transponder fees, violation records, violation fees, and/or other toll-related data. In general, the disclosed embodiments are configured to notify customers and/or fleet managers of possible issues with their accounts. The system is also configured to make automatic and/or suggest manual configuration changes or transponder changes in response to these detected issues. The disclosed embodiments are also configured for identifying the root causes of these issues, in order to make/suggest changes in the fleet management and operation.

Disclosed systems and methods are also configured to identify transactions that are not correlated to telematic data. By way of further example, a vehicle may not be moving (according to the telematics data corresponding to the vehicle) but the transponder is still incurring tolls. This could be due to the transponder being placed accidentally in the wrong vehicle and/or due to the transponder being stolen. Theft is a relatively large problem among fleet vehicles. If a transponder was stolen from a vehicle that is not being used very much, there is no way for a customer to know about it unless they are proactively watching the account. Disclosed systems and methods herein facilitate automated fraud detection by watching for the abnormal activity of vehicles and their corresponding transponders/license plates/or other vehicle identifiers.

Disclosed systems and methods are also configured to correlate toll transaction data to telematics that happen outside of a particular customer's business rules schema. Thus, the disclosed embodiments are configured to identify uncharacteristic or misuse of transponders. By way of further example, in some instances, a customer company has a policy that work trucks are not to be used after 6 pm. However, if the toll transaction data shows toll fees being incurred after 6 pm, the system is configured to identify this behavior and generate a notification of the customer as to the unauthorized toll fee incurrence. A customer/fleet manager is then able to take mitigating steps to ensure that further abuse is not undertaken by company employees.

By way of further example, disclosed systems and methods are configured to identify violations much earlier than is achieved by conventional systems and methods. Disclosed systems and methods are able to achieve improved violation detection because of the access to real-time telematics data for a vehicle or set of vehicles. Through traditional methods, some violations take days, weeks, or a complete invoice cycle to come to a customer's attention thereby incurring a significant increase in the number of violations and associated fines. By identifying violations in real-time or near real-time, the system is able to facilitate monetary savings for a customer by alerting the customer and/or fleet manager to the violation. This early-warning notification allows the customer to take mitigating action to prevent future violations and/or prevent late fees on current violations. Additionally, the system is able to determine whether or not the violation is accurate, based on comparing the violation against the telematic data.

Thus, the disclosed systems and methods are configured for identifying unexpected costs due to violations because the violations will be identified in near-real-time or real-time. By way of further example, in some instances, speed violations at toll booths cause transponders to be suspended. This happens automatically with the only notification being typically sent to the customer via mail. This is very expensive for a commercial fleet because they will now incur a violation for days or weeks until they understand they received a speed violation. To improve these conventional processes and toll-user experience, disclosed systems and methods facilitate improved notifications of such violations. In the case of the speed violation, the system is able to determine whether a speed violation has occurred in real-time or near real-time based on the telematics data that is recorded (e.g., the speed of the vehicle while passing through the toll booth).

Additionally, given the complex discount and violation structure, which is unique to each agency, the system is able to analyze the invoices for potential violations. For example, if the system is expecting and/or had predicted a toll bill of $10 but received a toll bill for $50, the system is configured to identify the source of the difference. In some instances, the source of the difference is a customer (e.g., driver) behavior, wherein the system is configured to suggest corrections in the customer's behavior. Additionally, or alternatively, the source of the difference is an error in the toll bill, wherein the system is configured to generate a dispute notification to the user and/or automatically file a dispute with the correct tolling agency.

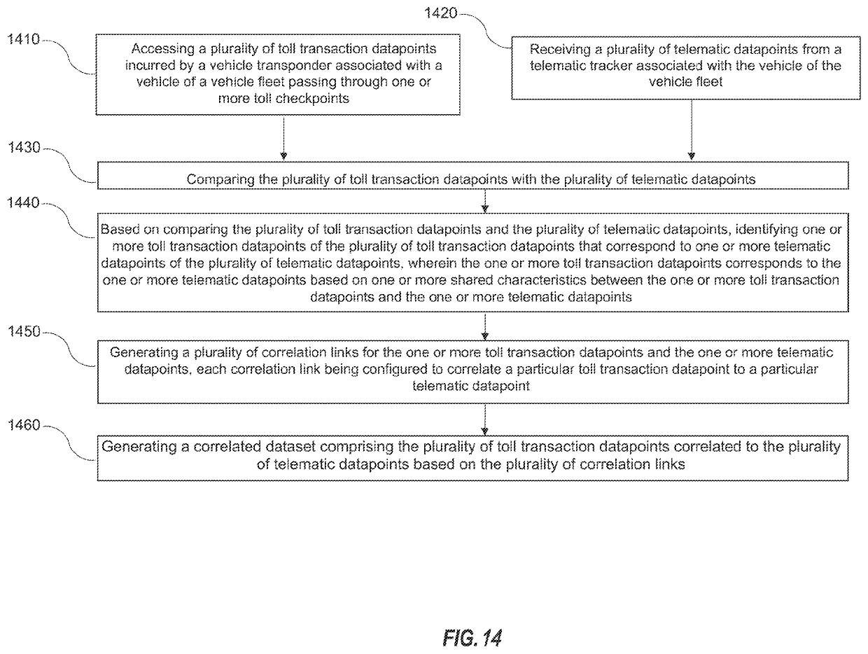

Attention will now be directed to FIG. 14, which illustrates a process flow diagram comprising a plurality of acts associated with a method for generating a correlated trip dataset comprising toll transaction data and telematic data. FIG. 14 illustrates a flow diagram that includes various acts (act 1410, act 1420, act 1430, act 1440, act 1450, and act 1460) associated with exemplary methods that can be implemented by computing system 110.

As shown in FIG. 14, the first illustrated act is directed to accessing a plurality of toll transaction data points incurred by a vehicle transponder associated with a vehicle of a vehicle fleet passing through one or more toll checkpoints (act 1410). In some instances, each toll transaction data point comprises a set of characteristics including a toll fee, a toll timestamp, a toll location, or a combination thereof.

Systems also receive a plurality of telematic data points from a telematic tracker associated with the vehicle of the vehicle fleet (act 1420). Subsequently, systems compare the plurality of toll transaction data points with the plurality of telematic data points (act 1430). In some instances, each telematic data point comprises a set of characteristics including a telematic timestamp, a telematic location, or a combination thereof.

Based on comparing the plurality of toll transaction data points and the plurality of telematic data points, systems identify one or more toll transaction data points of the plurality of toll transaction data points that correspond to one or more telematic data points of the plurality of telematic data points, wherein the one or more toll transaction data points corresponds to the one or more telematic data points based on one or more shared characteristics between the one or more toll transaction data points and the one or more telematic data points (act 1440). By implementing systems in this manner, systems are able to analyze the different data points and use characteristics from either plurality of data points in order to find corresponding data points that previously would have been difficult to identify.

After identifying the corresponding data points, systems generate a plurality of correlation links for the one or more toll transaction data points and the one or more telematic data points, each correlation link being configured to correlate a particular toll transaction data point to a particular telematic data point (act 1450). By generating correlation links, systems are able to use the correlation links to provide improved datasets and improved user interfaces for navigating and filtering those datasets by allowing users to view which data points correspond to each other.

Finally, systems generate a correlated dataset comprising the plurality of toll transaction data points correlated to the plurality of telematic data points based on the plurality of correlation links (act 1460). By generating a correlated dataset in this manner, systems are able to facilitate many improved downstream applications, such as error identification, dispute resolution, net present toll value determination, as well as improved user interfaces for accessing, navigating, and filtering data.

This correlated dataset can then be displayed at a user interface that is configured to facilitate improved access and navigation of telematic and toll transaction data. For example, systems display the plurality of toll transaction data points in a first location of a first window of a user interface and display the plurality of telematic data points in a second location of the first window of the user interface. In response to generating the correlated dataset, systems display the correlated dataset by dynamically updating the first window with a plurality of visual indicators associating the one or more toll transaction data points with the one or more telematic data points that correspond to the one or more toll transaction data points, the plurality of visual indicators being graphical representations of the plurality of correlations links.

Systems can utilize different methods to identify corresponding data points and identify shared characteristics between corresponding data points. For example, in some instances, systems also determine that the particular toll transaction data point correlates to the particular telematic data point based on determining that the toll timestamp of the particular toll transaction data point is similar to the telematic timestamp or that the toll location of the particular toll transaction data point is similar to the telematic data point of the particular telematic data point.

In some instances, systems normalize the toll transaction data and telematic data prior to additional analysis. For example, in some instances, prior to identifying one or more toll transaction fees that correlate with the one or more time-stamped coordinate data points, systems (i) normalize the set of toll transaction data from each toll agency of the one or more toll agencies according to a first predetermined standard formatting and (ii) normalize the set of telematic data to a second predetermined standard formatting that corresponds to the first predetermined standard.

In some instances, systems are able to identify specific trips or trip routes for a particular vehicle or set of vehicles based on analyzing the telematic data and/or toll transaction data. For example, systems identify a first coordinate location corresponding to a start of a trip route and a second coordinate location corresponding to an end of the trip route traveled by the vehicle and identify a first telematic data point corresponding to the first coordinate location and a second telematic data point corresponding to the second coordinate location.

Next, systems identify a subset of the plurality of telematic data points comprising the first telematic data point, the second telematic data point, and one or more consecutive telematic data points received from the telematic tracker between the first telematic data point and the second telematic data point. Based on the plurality of correlation links, systems identify a subset of the plurality of toll transaction data points that correspond to the subset of the plurality of telematic data points and generate a correlated trip dataset comprising the subset of the plurality of telematic data points and the subset of the plurality of toll transaction data points for the trip route traveled by the vehicle.

These correlated trip datasets are beneficially presented and navigable by a user at a user interface. For example, systems display in a second window an illustration of a geographical map. In response to identifying the first coordinate location, systems then dynamically update the second window by displaying a first icon at a first location of the geographical map that corresponds to the first coordinate location. Additionally, in response to identifying the second coordinate location, systems dynamically update the second window by displaying a second icon at a second location of the geographical map that corresponds to the second coordinate location. Finally, in response to identifying the subset of the plurality of telematic data points, systems also dynamically update the second window by displaying one or more additional icons. Each additional icon corresponds to a different consecutive telematic data point of the one or more consecutive telematic data points.

In some instances, systems further update the user display with toll transaction information. For example, in response to generating the correlated trip dataset, systems dynamically update each icon previously displayed in the second window of the user interface to be further selectable to further display toll transaction information from a corresponding toll transaction data point from the correlated trip dataset.

In some instances, systems are configured to identify incomplete trips based on incomplete telematic datasets. By identifying incomplete trips, systems are able to identify different portions of the same trip and combine the respective telematic datasets to represent a whole or complete trip. For example, systems identify a subset of the plurality of telematic data points comprising the first telematic data point, the second telematic data point, and one or more consecutive telematic data points received from the telematic tracker between the first telematic data point and the second telematic data point further comprises.

Systems also identify a first subset of the plurality of telematic data points comprising the first telematic data point but missing the second telematic data point and identify a second subset of the plurality of telematic data points comprising the second telematic data point but missing the first telematic datapoint.

Systems then determine that the first telematic data point corresponds to the second telematic data point as the start of the trip route and the end of the trip route, respectively. In response to determining that the different subsets of telematic data are portions of the same trip, systems combine the first subset of the plurality of telematic data points and the second subset of the plurality of telematic data points to generate the subset of the plurality of telematic data points such that the subset of the plurality of telematic data points corresponds to a complete trip route.

Systems and methods provided herein beneficially provide technical benefits such as facilitating the determination of a net present toll value and facilitating the automatic modification of trip routes based on meeting a net present toll value threshold. In order to calculate the net present toll value, systems determine the total cost of the trip route based on aggregating a set of toll fees included in the subset of the plurality of toll transaction data points included in the correlated trip dataset. Systems also determine a total time of the trip route based on a time difference between a first timestamp of the first telematic data point and a second time stamp of the second telematic data point included in the correlated trip dataset. Systems are then able to generate a net present toll value based on a combination of the total cost of the trip route and the total time of the trip route.

Some systems are configured to automatically modify a trip route if the corresponding net present toll value does not meet the net present toll value threshold. For example, systems identify a net present toll value threshold associated with the trip or set of trips and determine whether the net present toll value meets or exceeds the net present toll value threshold based on comparing the net present toll value against the net present toll value threshold.

In response to determining that the net present toll value meets or exceeds the net present toll value threshold, systems refrain from modifying a future trip route based on the trip route as traveled according to the correlated trip dataset. Alternatively, in response to determining that the net present toll value does not meet the net present toll value threshold, systems modify the future trip route.

The net present toll value and determination of whether the net present toll value threshold is met can be displayed to a user at a user interface. The user interface is also updated with potential trip modifications, including prompts to the user to confirm or deny the modifications. For example, in response to generating the net present toll value, systems dynamically update the second window to display the net present toll value at a third location of the second window.

In response to determining that the net present toll value meets or exceeds the net present toll value threshold, systems dynamically update the net present toll value according to a first formatting indicating that the net present toll value meets or exceeds the net present toll value threshold.

In response to determining that the net present toll value does not meet the net present toll value threshold, systems dynamically update the net present toll value according to a second formatting indicating that the net present toll value does not meet the net present toll value. Additionally, in response to modifying the future trip route, systems dynamically update the second window to display a modification to the trip route displayed using the geographical map. By implementing systems in this manner, users are able to visualize the trip modifications and corresponding increase in net present toll value in order to make more informed decisions and realize greater time and money savings.

There are different ways in which the system can modify a trip in order to facilitate a trip modification that will result in an increased net present toll value. For example, if a trip is incurring an excess in toll fees, without realizing sufficient time savings, the system may modify the route to avoid a certain toll road or set of toll roads in favor of a non-tolled route that has similar time estimates. Alternatively, if a non-tolled route is incurring too much time latency but a tolled route would provide decreased travel times, the system can modify the trip route to include the tolled portion of the route.

In other words, modifying the trip routes includes an additional toll transaction fee based on traveling through an additional tolled checkpoint between the first coordinate location and the second coordinate location such that the future trip corresponds to a new net present toll value that meets or exceeds the net present toll value threshold. Additionally, or alternatively, systems exclude a toll transaction fee in the correlated trip dataset based on refraining from traveling through a tolled checkpoint associated with the toll transaction fee such that the future trip corresponds to a new net present toll value that meets or exceeds the net present toll value threshold.

There are many technical benefits achieved by providing a correlated dataset of telematic and toll transaction data. For example, systems are achieving improved accuracy in predicting a toll bill for a particular trip of a vehicle. This improved predicted toll bill can then be used to compare with the actual toll bill to identify any errors in the toll bill. For example, systems access a toll information database comprising toll fee schedules and toll locations for different toll agencies. Based on the subset of the plurality of telematic data points for the trip route, systems identify one or more telematic data points that correspond to one or more toll fee schedules and toll locations included in the toll information database. Then, based on identifying the one or more telematic data points that correspond to the one or more toll fee schedules and toll locations included in the toll information database, systems predict one or more toll transactions for the trip route.

Systems also compare the predicted one or more toll transactions for the trip route with the subset of the plurality of toll transaction data points and identify a difference between at least one of the one or more toll transactions that were predicted for the trip route and at least one of the subset of the plurality of toll transaction data points. Finally, systems generate an alert message indicating that the at least one of the subset of the plurality of toll transaction data points includes an error.

Systems can also identify additional errors in the correlated dataset, including identifying toll transaction data points without corresponding telematic data points (i.e., extra toll bills that are improperly recorded or to detect abuse and fraud in the user of a vehicle transponder).

For example, systems predict a continuous route corresponding to the trip route based on the subset of the plurality of telematic data points and generate a new set of telematic data points comprising the subset of the plurality of telematic data points and a set of predicted coordinate data points located between different telematic data points of the subset of the plurality of telematic data points. Systems also identify one or more toll transaction data points from the subset of the plurality of toll transaction data points that were not included in the correlated trip dataset and that are predicted to correspond to the set of predicted coordinate data points and generate an alert message indicating that one or more toll transaction data points do not have a corresponding telematic data point included in the new set of telematic data points.

In some instances, systems are also configured to identify telematic data points that do not have corresponding toll transaction data points (i.e., unread transponder errors, and pre-violation identification). For example, systems access a toll checkpoint database comprising a plurality of toll checkpoint data points. Each toll check data point comprises a toll checkpoint location and a toll fee schedule. Systems query the subset of the plurality of telematic data points against the toll checkpoint database.

Based on querying the subset of the plurality of telematic data points against the toll checkpoint database, systems identify a telematic data point of the subset of the plurality of telematic data points that corresponds to a toll checkpoint data point included in the toll checkpoint database and determine that the telematic data point of the subset of the plurality of telematic data point does not correspond to a toll transaction data point of the subset of the plurality of toll transaction data points.

In response to determining that there is not a corresponding toll transaction data point, systems generate an alert message indicating that the telematic data point that should have had a corresponding toll transaction data point missing the corresponding toll transaction data point.

Some systems are also configured to detect abuse and fraud by comparing telematic trip data against a predicted set of telematic data. If there are discrepancies between the actual trip and the planned route, systems are configured to alert fleet managers. For example, systems identify a predetermined planned route associated with the trip route, the trip route being an actual trip route recorded using the telematic tracker and compare the subset of the plurality of the telematic data points with the predetermined planned route.

Based on comparing the subset of the plurality of the telematic data points with the predetermined planned route, systems identify a difference between the predetermined planned route and the subset of the plurality of the telematic data points. If a difference is identified, systems generate an alert message that the difference between the predetermined planned route and the subset of the plurality of the telematic data points has been identified.

In some instances, systems are also configured to monitor and modify tag distributions, in order to provide optimized tag distributions by relocating tag assignments to different home agencies in order to realize the greatest monetary savings across multiple fleets of vehicles. For example, systems access a tag fee database comprising tag fee information from a plurality of toll agencies and access a set of assigned vehicle tags associated with one or more customer fleets. Systems then compare the correlated dataset against the tag fee information included in the tag fee database. Based on comparing the correlated dataset against the tag fee information, systems determine whether one or more vehicle tags should be reassigned to a different location of a particular toll agency. In response to determining that one or more vehicle tags should be reassigned to the different locations of the particular toll agency, systems modify the set of assigned vehicles by reassigning one or more vehicle tags to the different locations of the particular toll agency.

In view of the foregoing, it will be appreciated that the disclosed embodiments provide many technical benefits over conventional systems and methods for fleet management.

### Example Computer Systems

Embodiments of the present invention may comprise or utilize a special-purpose or general-purpose computer (e.g., computing system 110) including computer hardware, as discussed in greater detail below. Embodiments within the scope of the present invention also include physical and other computer-readable media for carrying or storing computer-executable instructions and/or data structures, which are executable for configuring the disclosed systems to implement the disclosed functionality. Such computer-readable media can be any available media that can be accessed by a general-purpose or special-purpose computer system.

Computer-readable media (e.g., hardware storage device(s) 140 of FIG. 1) that store computer-executable instructions (e.g., computer-readable instructions 118 of FIG. 1) are physical hardware storage media/devices that exclude transmission media. Computer-readable media that carry computer-executable instructions or computer-readable instructions (e.g., computer-readable instructions 118) in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 130 of FIG. 1) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry, or desired program code means in the form of computer-executable instructions or data structures, and which can be accessed by a general purpose or special purpose computer Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method implemented by a computing system for generating a correlated trip dataset, the method comprising:
accessing a plurality of toll transaction data points incurred by a vehicle transponder associated with a vehicle of a vehicle fleet passing through one or more toll checkpoints;
receiving a plurality of telematic data points from a telematic tracker associated with the vehicle of the vehicle fleet;
comparing the plurality of toll transaction data points with the plurality of telematic data points;
based on comparing the plurality of toll transaction data points and the plurality of telematic data points, identifying one or more toll transaction data points of the plurality of toll transaction data points that correspond to one or more telematic data points of the plurality of telematic data points, wherein the one or more toll transaction data points corresponds to the one or more telematic data points based on one or more shared characteristics between the one or more toll transaction data points and the one or more telematic data points;
generating a plurality of correlation links for the one or more toll transaction data points and the one or more telematic data points, each correlation link being configured to correlate a particular toll transaction data point to a particular telematic data point; and
generating a correlated dataset comprising the plurality of toll transaction data points correlated to the plurality of telematic data points based on the plurality of correlation links.

2. The method of claim 1, further comprising:
displaying the plurality of toll transaction data points in a first location of a first window of a user interface;
displaying the plurality of telematic data points in a second location of the first window of the user interface; and
in response to generating the correlated dataset, displaying the correlated dataset by dynamically updating the first window with a plurality of visual indicators associating the one or more toll transaction data points with the one or more telematic data points that correspond to the one or more toll transaction data points, the plurality of visual indicators being graphical representations of the plurality of correlations links.

3. The method of claim 1, wherein each toll transaction data point comprises a set of characteristics including a toll fee, a toll timestamp, a toll location, or a combination thereof.

4. The method of claim 3, wherein each telematic data point comprises a set of characteristics including a telematic timestamp, a telematic location, or a combination thereof.

5. The method of claim 3, further comprising:
determining that the particular toll transaction data point correlates to the particular telematic data point based on determining that the toll timestamp of the particular toll transaction data point is similar to the telematic timestamp or that the toll location of the particular toll transaction data point is similar to the telematic data point of the particular telematic datapoint.

6. The method of claim 1, further comprising:
prior to identifying one or more toll transaction fees that correlate with the one or more telematic data points,
(i) normalizing the plurality of toll transaction data points from each toll agency of the one or more toll agencies according to a first predetermined standard formatting; and
(ii) normalizing the plurality of telematic data points to a second predetermined standard formatting that corresponds to the first predetermined standard.

7. The method of claim 1, further comprising:
identifying a first coordinate location corresponding to a start of a trip route and a second coordinate location corresponding to an end of the trip route traveled by the vehicle;
identifying a first telematic data point corresponding to the first coordinate location and a second telematic data point corresponding to the second coordinate location;
identifying a subset of the plurality of telematic data points comprising the first telematic data point, the second telematic data point, and one or more consecutive telematic data points received from the telematic tracker between the first telematic data point and the second telematic data point;
based on the plurality of correlation links, identifying a subset of the plurality of toll transaction data points that correspond to the subset of the plurality of telematic data points; and
generating a correlated trip dataset comprising the subset of the plurality of telematic data points and the subset of the plurality of toll transaction data points for the trip route traveled by the vehicle.

8. The method of claim 7, further comprising:
displaying in a second window an illustration of a geographical map at a user interface;
in response to identifying the first coordinate location, dynamically updating the second window by displaying a first icon at a first location of the geographical map that corresponds to the first coordinate location;
in response to identifying the second coordinate location, dynamically updating the second window by displaying a second icon at a second location of the geographical map that corresponds to the second coordinate location; and
in response to identifying the subset of the plurality of telematic data points, dynamically updating the second window by displaying one or more additional icons, each additional icon corresponding to a different consecutive telematic data point of the one or more consecutive telematic data points.

9. The method of claim 8, further comprising:
in response to generating the correlated trip dataset, dynamically updating each icon previously displayed in the second window of the user interface to be further selectable to further display toll transaction information from a corresponding toll transaction data point from the correlated trip dataset.

10. The method of claim 7, further comprising:
determining a total cost of the trip route based on aggregating a set of toll fees included in the subset of the plurality of toll transaction data points included in the correlated trip dataset;
determining a total time of the trip route based on a time difference between a first timestamp of the first telematic data point and a second time stamp of the second telematic data point included in the correlated trip dataset;
generating a net present toll value based on a combination of the total cost of the trip route and the total time of the trip route.

11. The method of claim 10, further comprising:
identifying a net present toll value threshold;
determining whether the net present toll value meets or exceeds the net present toll value threshold based on comparing the net present toll value against the net present toll value threshold;
in response to determining that the net present toll value meets or exceeds the net present toll value threshold, refraining from modifying a future trip route based on the trip route as traveled according to the correlated trip dataset, or alternatively in response to determining that the net present toll value does not meet the net present toll value threshold, modifying the future trip route.

12. The method of claim 11, further comprising:
in response to generating the net present toll value, dynamically updating a second window to display the net present toll value at a third location of the second window;
in response to determining that the net present toll value meets or exceeds the net present toll value threshold, dynamically updating the net present toll value according to a first formatting indicating that the net present toll value meets or exceeds the net present toll value threshold.

13. The method of claim 11,
in response to determining that the net present toll value does not meet the net present toll value threshold, dynamically updating the net present toll value according to a second formatting indicating that the net present toll value does not meet the net present toll value; and
in response to modifying the future trip route, dynamically updating a second window to display a modification to the trip route displayed using a geographical map.

14. The method of claim 11, wherein modifying the future trip route includes:
including an additional toll transaction fee based on traveling through an additional tolled checkpoint between the first coordinate location and the second coordinate location such that the future trip route corresponds to a new net present toll value that meets or exceeds the net present toll value threshold.

15. The method of claim 1, further comprising:
accessing a toll information database comprising toll fee schedules and toll locations for different toll agencies;
based on a subset of the plurality of telematic data points for a trip route, identifying one or more telematic data points that correspond to one or more toll fee schedules and toll locations included in the toll information database;
based on identifying the one or more telematic data points that correspond to the one or more toll fee schedules and toll locations included in the toll information database, predicting one or more toll transactions for the trip route;
comparing the predicted one or more toll transactions for the trip route with the subset of the plurality of toll transaction data points;
identifying a difference between at least one of the one or more toll transactions that were predicted for the trip route and at least one of the subset of the plurality of toll transaction data points; and
generating an alert message indicating that the at least one of the subset of the plurality of toll transaction data points includes an error.

16. The method of claim 7, further comprising:
predicting a continuous route corresponding to the trip route based on the subset of the plurality of telematic data points;
generating a new set of telematic data points comprising the subset of the plurality of telematic data points and a set of predicted coordinate data points located between different telematic data points of the subset of the plurality of telematic data points;
identifying one or more toll transaction data points from the subset of the plurality of toll transaction data points that were not included in the correlated trip dataset and that are predicted to correspond to the set of predicted coordinate data points; and
generating an alert message indicating that one or more toll transaction data points do not have a corresponding telematic data point included in the new set of telematic data points.

17. The method of claim 7, further comprising:
accessing a toll checkpoint database comprising a plurality of toll checkpoint data points, each toll check data point comprising a toll checkpoint location and a toll fee schedule;
querying the subset of the plurality of telematic data points against the toll checkpoint database;
based on querying the subset of the plurality of telematic data points against the toll checkpoint database, identifying a telematic data point of the subset of the plurality of telematic data points that corresponds to a toll checkpoint data point included in the toll checkpoint database;
determining that the telematic data point of the subset of the plurality of telematic data points does not correspond to a toll transaction data point of the subset of the plurality of toll transaction data points; and
generating an alert message indicating that the telematic data point that should have had a corresponding toll transaction data point is missing the corresponding toll transaction data point.

18. The method of claim 1, further comprising:
accessing a tag fee database comprising tag fee information from a plurality of toll agencies;
accessing a set of assigned vehicle tags associated with one or more customer fleets;
comparing the correlated dataset against the tag fee information included in the tag fee database;
based on comparing the correlated dataset against the tag fee information, determining whether one or more vehicle tags should be reassigned to a different location of a particular toll agency; and
in response to determining that one or more vehicle tags should be reassigned to the different locations of the particular toll agency, modifying the set of assigned vehicles by reassigning one or more vehicle tags to the different locations of the particular toll agency.

19. The method of claim 7, further comprising:
identifying a predetermined planned route associated with the trip route, the trip route being an actual trip route recorded using the telematic tracker;
comparing the subset of the plurality of the telematic data points with the predetermined planned route;
based on comparing the subset of the plurality of the telematic data points with the predetermined planned route, identifying a difference between the predetermined planned route and the subset of the plurality of the telematic data points; and
generating an alert message that the difference between the predetermined planned route and the subset of the plurality of the telematic data points has been identified.

20. The method of claim 7, wherein identifying the subset of the plurality of telematic data points comprising the first telematic data point, the second telematic data point, and one or more consecutive telematic data points received from the telematic tracker between the first telematic data point and the second telematic data point further comprises:
identifying a first subset of the plurality of telematic data points comprising the first telematic data point but missing the second telematic data point;
identifying a second subset of the plurality of telematic data points comprising the second telematic data point but missing the first telematic data point;
determining that the first telematic data point corresponds to the second telematic data point at the start of the trip route and the end of the trip route, respectively; and
combining the first subset of the plurality of telematic data points and the second subset of the plurality of telematic data points to generate the subset of the plurality of telematic data points such that the subset of the plurality of telematic data points corresponds to a complete trip route.
